(19) United States
(12) Patent Application Publication
(10) Pub. No.: US 2026/0270075 A1
(43) Pub. Date: Sep. 10, 2026

(54) BEHAVIORAL ECONOMIC IDENTITY (BEI) TIME-LAND-RESOURCE DOMAIN SOVEREIGN REGISTRATION OPERATING SYSTEM WITH MULTIDIMENSIONAL NONDUP GATE, EXECUTABLE POLICY CONTAINER, CRYPTOGRAPHICALLY-CHAINED PROOF ARTIFACT PIPELINE, AND BOUNDED REMEDIATION SUBSYSTEM

(71) Applicant: FURONG BEI, San Gabriel, CA (US)

(72) Inventor: FURONG BEI, San Gabriel, CA (US)

(21) Appl. No.: 19/691,470

(22) Filed: May 28, 2026

(51) Int. Cl. H04L 9/32

(52) U.S. Cl. CPC H04L 9/3236; H04L 9/3218; H04L 9/3247

(57) ABSTRACT

A computer-implemented Behavioral Economic Identity (BEI) Time-Land-Resource Domain registration operating system transforms a registration intent into an active, proof-carrying, policy-governed BEI Operating Node rather than a passive domain-name record. The system receives a BEI registration intent envelope, canonicalizes a requested time-land-resource scope, generates or binds a BEI Doorplate or BEDID, and executes a multidimensional NonDup/NonConflict/NonOverlap controller over label, identity, time, land or resource, territory, franchise, retail, market, and policy dimensions. Responsive to an allowed result, the system creates a BEITLD root record, injects an executable PolicyContainer, activates a classified BEI Operating Node, and generates proof artifacts including a Resolution Receipt, NonDuplicationReceipt, authorization or clearing receipt, and FinalityMarker. The FinalityMarker provides activation pointers for ATMS synchronization, market listing, index routing, governance transition, verifier reconstruction, and BEIFR2 bounded remediation with dependency-graph and quantitative bounds.

### CROSS-REFERENCE TO RELATED APPLICATIONS AND ADS COORDINATION

This application is drafted as a continuation-in-part style application and ecosystem companion filing directed to a BEI Time-Land-Resource Domain registration operating system. Any domestic benefit, continuation, continuation-in-part, divisional, priority, or other continuity relationship intended to be relied upon is claimed only to the extent properly set forth in an Application Data Sheet or other accepted USPTO filing record. The cross-reference language in this specification is intended to coordinate technical disclosure and claim support and is not a substitute for a formal ADS benefit claim.

Subject to the Application Data Sheet, the present application may claim benefit of, be a continuation-in-part of, or otherwise be related to one or more earlier BEI, ATMS, DomainPI, BEIDNS, BEIFR2, BEIChip, BEIMINT, BEI Currency, TimeCurrency, BEIGX, BEIIndex, DomainYLD, and sector-node applications. Such related applications collectively disclose domain-resolved banking, decentralized identity, DID-NFT identity anchoring, domain and subdomain node activation, behavior-linked issuance, minting, banking, clearing, settlement, bounded rollback, trusted execution, receipt chains, resolution-as-evidence, multi-rail settlement, digital-land and domain-parcel routing, module packages, industry nodes, and transferable asset-package deployment.

The present application uses the related infrastructure as contextual and implementation support but addresses a distinct registration-origin technical problem: how a BEI Time-Land-Resource Domain request is received, canonicalized, checked for non-duplication and boundary conflict, assigned to a BEI Doorplate or BEDID, transformed into a machine-readable root record, and activated as a policy-governed BEI Operating Node. Accordingly, the registration event itself produces an auditable, clearable, searchable, licensable, remediable, and governance-aware operating node rather than merely creating a passive Internet domain record.

ADS coordination may be maintained in a separate filing record or data-room schedule and is not part of a formal priority or domestic-benefit claim unless included in the Application Data Sheet or another USPTO-accepted filing record.

### TECHNICAL FIELD

The disclosure relates to computer-implemented registry systems, domain-name infrastructures, behavioral economic identity systems, digital asset control planes, time-land-resource namespaces, clearing and settlement systems, proof-carrying receipts, policy containers, and bounded remediation state machines. More particularly, the disclosure relates to a BEI registration operating system in which a domain-like registration event activates a BEI Doorplate or BEDID as a Time-Land-Resource Operating Node configured for identity, policy, proof, ATMS synchronization, market listing, franchise or retail deployment, governance, and BEIFR2 correction.

The disclosed system may be implemented by registry servers, resolver gateways, signed endpoint stores, deterministic policy containers, identity anchors, trusted execution services, clearing kernels, data-room engines, and validation nodes. In some embodiments, the system operates as an overlay or companion to conventional DNS, registrar, RDAP, banking, marketplace, and identity infrastructure while producing proof artifacts that are specific to BEI Time-Land-Resource Domain registration.

### Background and Technical Problem

Conventional domain registrars primarily receive a name request, check availability within a namespace, collect registrant information and payment, create registry records, configure DNS or nameserver data, and support renewal, transfer, suspension, deletion, or dispute handling. Such registrars generally do not convert a registered name into a behavior-economic identity operating node having a policy container, proof chain, clearing endpoint, value-state search interface, franchise or retail node classification, bounded remediation boundary, or standards compliance record.

Conventional digital identity systems, decentralized naming systems, financial rails, marketplaces, token systems, and governance systems remain fragmented. A subject may have a name, a wallet, a credential, a payment account, a store account, a business franchise, a public-service identity, a medical node, or a domain record, but those records are not created by a single registration-origin process that binds identity, time, land, resource scope, policy, proof, settlement, market eligibility, and remediation constraints at the moment of registration.

### Conventional Registrar Workflow and BEITLD Machine Re-Definition

A conventional registrar workflow may include name search, availability check, registrant data capture, fee collection, registry record creation, DNS delegation, renewal, transfer, lock, dispute, and deletion. The present BEITLD workflow performs analogous workflow stages but changes the machine output of registration. A search operation becomes a BEI value-state and availability resolution. An availability check becomes a NonDup, NonConflict, and NonOverlap analysis over identity, label, time, land, resource, territory, franchise, retail, market, and policy scopes. A registry record becomes a Time-Land-Resource Domain Root Record. A DNS record becomes a signed endpoint and proof-discovery object. A registrant becomes an applicant BEDID or BEI Doorplate subject. A domain lifecycle state becomes an operating-node state machine.

The system thereby redefines registration as a machine transformation from request to operating node. The request is not granted merely because a string is unused. The request is granted only after canonicalization, scope hashing, policy selection, identity binding, conflict analysis, proof generation, audit commitment, and finality marking. The result may be operated, licensed, cleared, indexed, transferred, franchised, retailed, listed, suspended, reinstated, or remediated according to data structures stored in or referenced by the registry.

### Traditional Domain Registrar Feature Mapping and BEITLD Technical Redefinition

Conventional registrar platforms may provide domain search, availability determination, domain registration, DNS record creation or resolution, renewal, transfer, ownership lookup, privacy or proxy services, bundled website or email offerings, business-service connections, marketplace listings, auctions, and appraisal tools. The disclosed BEITLD registry may present analogous user-facing steps, but the back-end machine output is a different data structure and state: an active BEI Time-Land-Resource Operating Node rather than a passive name record.

Domain search is redefined as BEI value-state search. Instead of returning only string availability, the registry may return availability_state, conditional_state, policy_gate, nondup_score, pending_lock status, public-interest hold, required RFP route, expected node class, ATMS route, disclosure level, and remediation status.

Registration is redefined as operating-node activation. Instead of merely creating a registry row or DNS delegation, the registry generates or binds a BEDID or BEI Doorplate, creates a BEITLD root record, injects a PolicyContainer, creates proof artifacts, issues a FinalityMarker, and activates routes for clearing, market, index, governance, and remediation.

DNS or resolution functions are redefined as resolution-as-evidence. A lookup may produce a Resolution Receipt or denial receipt with reason code, policy hash, policy version, scope-token digest, revocation reference, rollback reference, time-to-live value, audit anchor, and signature chain.

Renewal, transfer, lock, suspension, reinstatement, and deletion functions are redefined as receipt-bound lifecycle transitions of a BEI Operating Node. Each lifecycle transition may require policy validation, NonDup or scope recheck, proof generation, FinalityMarker update, and BEIFR2 boundary preservation.

WHOIS or RDAP-like owner lookup is redefined as selective disclosure. Public records may show node existence, lifecycle state, policy version, and integrity proofs, while sensitive identity, medical, financial, location, franchise, or resource fields remain behind scope-token or zero-knowledge disclosure controls.

Registrar bundles are redefined as node-class and PolicyContainer bundles. A selected package may correspond to a personal node, household node, franchise node, chain node, retail node, medical node, financial node, education node, public-service node, IoT node, AI-agent node, or data-room node, each with different policy, proof, clearing, index, market, standards, and remediation routes.

Marketplace, auction, appraisal, or data-room functions are redefined as BEIMarket, BEIIndex, BEIGDP, DomainYLD, DataRoomRecord, and Claim-to-SKU output routes. These routes are technical records and evidence packages and do not, by themselves, guarantee legal title, securities status, market value, income, or transaction completion.

### Summary of the Registration-Origin Invention

The system receives a BEI registration intent envelope identifying an applicant, a requested label or doorplate, a requested time-land-resource scope, a node class, evidence digests, policy templates, signatures, time anchors, and optionally RFP, territory, franchise, chain, retail, market, clearing, index, or governance scopes. The system canonicalizes the envelope, computes deterministic digests, validates authority and time constraints, and routes the request to a NonDup controller.

The NonDup controller evaluates whether the request collides with existing records or pending requests in one or more namespaces. The controller may evaluate string-name collisions, identity collisions, Time-of-Time window collisions, land or resource boundary overlaps, territory conflict, franchise overlap, retail-node conflict, market-listing duplication, policy version collision, payment or ATMS replay, and remediation hold states. The system outputs a NonDuplicationReceipt, ConflictReport, NonOverlapCertificate, or denial receipt with a machine-readable reason code.

When the registration is allowed, the registry creates or binds a BEDID or BEI Doorplate, creates a BEITLD root record, injects an executable PolicyContainer, provisions signed endpoints, generates proof artifacts, activates a BEI Operating Node, and exposes downstream endpoints including value-state search, ATMS synchronization, BEIMarket listing, BEIGDP or BEIIndex routing, BIRSTDSEC standards binding, BEINation governance, and BEIFR2 bounded remediation.

### Definitions

BEI means Behavioral Economic Identity and refers to an identity, account, node, doorplate, or record associated with a subject, object, institution, family, device, territory, resource, behavior event, or operational unit in a behavioral-economic system. BEI may be bound to cryptographic keys, credentials, time proofs, policy profiles, receipts, value records, or governance states.

BEITLD means a BEI Time-Land-Resource Domain registration layer. TLD in this disclosure may be redefined as Time Land Domain, Time-Land-Resource Domain, or a domain-like registry class that operates as a root or sub-root for identity, time, land, resource, territory, franchise, chain, retail, market, governance, and remediation records.

BEI Doorplate or BEDID means a machine-readable identifier or doorplate allocated or bound by the registry to represent an applicant, node, location, service, asset, chain, retail store, family, industry, region, country, public-service endpoint, market listing, franchise right, or other operating node. A BEDID may include references to identity anchors, time anchors, root records, policy containers, signed endpoint records, receipts, and remediation boundaries.

### Registration Intent Envelope

A RegistrationIntentEnvelope may include applicant_bedid, applicant_identity_anchor, applicant_signature_set, requested label, requested_time_land_resource_scope, requested_node_class, requested_territory_scope, requested_industry_scope, requested_franchise_scope, requested_retail_scope, requested_market_scope, evidence_digest, capacity_digest, governance_commitment_digest, policy_template_id, nondup_scope key, payment_or_ATMS_reference, rfp_reference, trusted_time_reference, nonce, expiration, and version fields.

The system canonicalizes the envelope using a fixed field order, normalized label encoding, standardized scope descriptors, and deterministic digest generation. The canonical envelope produces an intent_digest used by the NonDup controller, policy container, proof pipeline, audit gate, and downstream clearing or listing services. In some embodiments, a scope_hash and time_hash are derived from a secure scope resolver and temporal resolver before policy execution.

### BEI Doorplate and BEDID Binding

The system may generate a new BEI Doorplate, bind an existing BEDID, or reserve a provisional doorplate while a request is under review. Doorplate allocation may depend on eligibility status, identity proof, RFP award state, territory class, industry class, service class, market class, or compliance state. A doorplate may function as an address, identity anchor, node identifier, signed endpoint pointer, policy anchor, clearing reference, and data-room subject.

The registry may record a DoorplateBindingRecord including bedid, doorplate_label, subject_type, identity_anchor_hash, time_anchor_reference, root_record_id, policy_container_id, nondup_receipt_id, operating_node_id, activation_state, authorized_node_classes, and remediation_boundary_reference. The record may be public, privacy-filtered, or selectively disclosed using scope tokens.

### Time-Land-Resource Domain Root Record

The BEITLD Root Record is a registry object that represents the registered time-land-resource domain. It may include root_record_id, canonical_label, bedid, doorplate_reference, node_class, time_scope, land_scope, resource_scope, territory_scope, industry_scope, parent_root_id, child_node_policy, policy_container_id, signed_endpoint_set, RRec_root, ACR_root, finality_marker_id, ATMS_endpoint, BEIIndex_route, BEIGDP_route, BEIMarket_route, BEIFR2_boundary, and lifecycle_state.

The root record may be generated only after the NonDup controller authorizes registration or after a conflict is resolved. A root record may remain in reserved, pending, active, delegated, franchised, chained, retail-enabled, market-listed, suspended, frozen, remediated, transferred, archived, or retired state. State transitions may require audit commitments and receipt generation.

### NonDup NonConflict and NonOverlap Registration Gate

The NonDup gate is a technical registration gate, not merely a string availability check.

The gate may search label namespaces, BEI Doorplate indexes, identity hashes, time windows, land and resource boundaries, jurisdictional zones, operator scopes, franchise territories, chain branch sets, retail store locations, market listings, policy containers, payment references, and remediation holds. The gate may evaluate both final records and pending locks to prevent race conditions.

Reason codes may include RC_LABEL_RESERVED, RC_LABEL_DUPLICATE, RC_IDENTITY_COLLISION, RC_TIME_WINDOW_OVERLAP, RC_LAND_SCOPE_OVERLAP, RC_RESOURCE_SCOPE_CONFLICT, RC_TERRITORY_CONFLICT, RC_FRANCHISE_OVERLAP, RC_RETAIL_NODE_CONFLICT, RC_MARKET_LISTING_DUPLICATE, RC_POLICY_COLLISION, RC_ATMS_REPLAY, RC_PAYMENT_UNCONFIRMED, RC_SCOPE_TOKEN_EXPIRED, RC_BEIFR2_HOLD, RC_STANDARDS_PROFILE_FAIL, and RC_MANUAL_REVIEW_REQUIRED.

### Executable PolicyContainer

The PolicyContainer is an executable or machine-interpretable policy bundle injected into the root record or linked endpoint set. The PolicyContainer may define registration eligibility, identity requirements, evidence requirements, data-disclosure rules, territory rules, franchise rules, chain expansion rules, retail permissions, market listing constraints, ATMS settlement parameters, royalty basis, index publication conditions, governance rights, standards compliance, revocation rules, and BEIFR2 remediation boundaries.

In some embodiments, the PolicyContainer includes C3 policy components: commercial or clearing policy, content or evidence policy, and conduct or service policy. The container may be versioned and signed. A policy version may be bound to RRec, ACR, FinalityMarker, NDR, RBP, ATMS receipt, market listing, and governance transition records.

### Operating Node Activation

Upon approval, the system activates a BEI Operating Node. The node may be a basepoint, territory node, RFP operator node, franchise node, chain node, retail node, market node, medical node, ATMS node, index node, governance node, resolver node, data-room node, or sector node. The activation state machine may progress through reserved, queued, nondup_checked, policy_bound, root_record_created, endpoint_provisioned, proof_generated, initialized, active, delegated, market_listed, suspended, remediated, transferred, or archived states.

Each state transition may generate a receipt and may be reconstructed by a verifier from the canonical intent, root record, policy version, pre-state digest, post-state digest, audit anchor, prior receipt hash, and signature chain. Accordingly, registration does not simply write a database row; registration causes a controlled state transition in a registry operating system.

### Proof Artifact Pipeline

The proof artifact pipeline may generate a Registration Receipt, Resolution Receipt or RRec, Authorization/Clearing Receipt or ACR, FinalityMarker, NonDuplicationReceipt or NDR, Rollback Proof or RBP, RemediationReceipt, MarketListingReceipt, FranchiseScopeReceipt, RetailNodeReceipt, ATMSReceipt, and GovernanceTransitionReceipt. Each proof artifact may be stored in an append-only log, ledger, secure registry, or audit repository.

The FinalityMarker is a machine-readable terminal activation object and not merely a label. The FinalityMarker may comprise fm_id, root_record_id, node_state, proof_root_hash, audit_anchor, ATMS pointer, BEIMarket pointer, BEIGDP pointer, BEIFR2 boundary, state-transition log, cryptographic seal, and timestamp. The FinalityMarker may be generated only after the proof artifact pipeline reaches an authorized terminal state.

### BEIDNS Resolution-as-Evidence Layer

Before registration, the system may use a BEIDNS or resolution-as-evidence layer to resolve a requested identifier, match a basepoint in a curated identifier reservoir, evaluate a versioned policy container, validate scope tokens, and return an RRec. If the RRec allows registration, the allowed resolution may be transformed into a RegistrationIntentEnvelope. If the resolution is denied, the system may return a denial receipt with reason codes and remediation steps.

After registration, the same layer may provide access to the operating node. Different requestors may receive different field-level views based on policy, identity, scope token, role, time window, and compliance state. For example, a public user may see public node status, a franchise operator may see operational scopes, a clearing service may see ATMS routes, a regulator may see compliance proofs, and a data-room viewer may see license-package manifests.

### BEIRFP and Operator Selection

The system may include a BEIRFP intake and operator-selection portal. The portal receives proposals for global, regional, industry, system, store, franchise, standards, market, data-room, or governance operation. A selected proposal may generate an RFP-to-BEITLD Registration Intent Envelope including rfp_id, applicant_bedid, requested_scope_type, requested_region, requested_industry, requested_system, proposal_digest, evidence_digest, capacity_digest, governance_commitment_digest, policy_template_id, nondup_scope_key, review_score, and award_status.

Upon selection, the registry may register the operator as a BEI Operating Node and create operator root records, scope tokens, authority markers, policy containers, NonDuplicationReceipts, proof artifacts, ATMS settlement references, BEIMarket license records, and BEIFR2 remediation boundaries.

### Territory Franchise Retail and Market Node Classes

A node_class field may classify the registered node as BEI_NODE, BEI_TERRITORY, BEI_FRANCHISE, BEI_CHAIN, BEI_RETAIL, BEI_MARKET, BEI_RFP_OPERATOR, BEI_MEDICALCENTER, BEI_ATMS_NODE, BEI_INDEX_NODE, BEI_GOVERNANCE_NODE, or another class. Each class may activate different required fields, policy modules, proof artifacts, and downstream endpoints.

A BI Franchise node may include franchisor_bedid, franchisee_bedid, territory_scope, industry_scope, license_term, royalty_basis, compliance_profile, marketing_scope, standards_profile, and remediation_boundary. A BI Chain node may include parent node_id, branch_node_set, franchise_node_set, retail_node_set, shared_brand_policy, shared_ATMS_route, shared_BEIGDP_route, and chain_audit_state. A BI Retail node may include store_doorplate, service_scope, location_or_online_scope, terminal_endpoint_set, inventory_or_service_category, ATMS_payment_endpoint, customer_service_endpoint, retail_compliance_profile, and receipts.

A selected BEITLD parent namespace, BEI Time-Land-Resource registry class, or parent BEI Operating Node may generate personalized second-level domain nodes, subdomain nodes, territory nodes, franchise nodes, chain nodes, retail nodes, medical nodes, financial nodes, education nodes, government nodes, family nodes, device nodes, IoT nodes, or market nodes.

Each child node may inherit one or more parent PolicyContainer rules, governance boundaries, standards profiles, license terms, endpoint templates, or BEIFR2 remediation boundaries, but each child node is independently canonicalized and evaluated by the multidimensional NonDup/NonConflict/NonOverlap controller before activation.

A ChildNodeSpawnRecord may include spawn_id, parent_root_record_id, parent_bedid, child_bedid, child_node_class, selected_parent_namespace, scope_containment_proof, policy_inheritance_digest, independent_nondup_receipt_id, child_finality_marker_id, and spawn_timestamp_fields. The scope_containment_proof demonstrates that the child node remains within the authorized parent scope; the policy_inheritance_digest identifies the parent rules inherited by the child; and the independent_nondup_receipt_id proves that the child node was separately checked before activation.

In one embodiment, ChildNode.spawn(parent_node, child_request) verifies that the parent PolicyContainer permits the requested child node class, canonicalizes the requested child label or subdomain, computes the child scope hash, compares the child scope against parent territory, franchise, retail, market, standards, and remediation boundaries, executes an independent NonDup check for the child, creates a child root record, binds inherited policy rules, and issues a child FinalityMarker. This implements personalized second-level domain nodes and subdomain nodes without allowing uncontrolled expansion beyond the parent BEITLD namespace.

### ATMS and Deterministic Clearing Integration

An activated node may invoke ATMS and deterministic clearing services for registration fees, RFP fees, franchise fees, retail transactions, market listings, royalty flows, TimeCurrency conversion, BEI Currency issuance, settlement adjustments, and remediation corrections. A human-readable namespace address may be resolved into a hierarchical account graph. A canonical transaction envelope may produce a tx_hash. A nonce gate may prevent replay. A ledger execution engine may perform atomic debit-credit transformations and produce a verifier-reconstructable proof set.

A settlement matrix may distribute value among retail node, franchise node, territory operator, registry operator, ATMS service, BEIMarket, BEIIndex, BEIGDP publisher, governance treasury, standards body, or remediation reserve. Legacy rail adapters may bind rail_payload_digest and rail_ack_digest during two-phase bridging to conventional payment networks, while preserving auditability and receipt chains.

### BEIGDP BEIIndex DRIDX and Data-Room Routing

The root record may expose index routes for BEIGDP, BEIIndex, DomainYLD, DRIDX, market evidence, and data-room outputs. These outputs are not asserted as financial guarantees; they are data structures or computation routes through which registered node activity, proofs, receipts, settlement records, licensing states, and policy versions may be summarized or indexed for machine evaluation.

A DataRoomRecord may include node_id, root_record_id, claim_support_pointer, patent_family_pointer, domain_asset_pointer, trademark_pointer, policy_version, endpoint_manifest, proof artifact set, market_listing_id, license_field, royalty_basis, risk_disclosure, audit_anchor, and remediation_status. Such records improve due-diligence traceability by mapping technical modules to registered nodes and proof artifacts.

### BEIFR2 Bounded Remediation

BEIFR2 bounded remediation may be triggered by duplicate registration, identity binding error, fraud report, court order, policy version error, franchise overlap, retail node conflict, market listing conflict, ATMS replay, endpoint compromise, standards failure, or governance decision. A remediation request may create a Forensic Receipt Object or RBP including pre-remediation snapshot hash, affected root records, remediation scope, trigger vector, policy authorization, rebind state, post-remediation state hash, impact_set_digest, and receipt signature.

The remediation engine may compute a blast radius using dependency graphs, time windows, land and resource scopes, franchise trees, retail branch sets, market listings, settlement receipts, and prior receipt hashes. The system may freeze, quarantine, reroute, rebind, rollback, mark as remediated, reinstate, or archive only affected nodes, while preserving unrelated nodes and prior anchor records.

### BIRSTDSEC Standards Practice and Governance Layer

The system may bind BIRSTDSEC standards and practice profiles to a root record or policy container. A standards profile may define field schemas, algorithm identifiers, signature requirements, audit retention, privacy filtering, scope-token rules, remediation deadlines, reason-code taxonomy, dispute-routing procedures, and interoperability mappings. Updates to standards profiles may be bound to ledger evidence or governance receipts.

Governance transitions may include operator appointment, operator suspension, standards update, territory split, franchise expansion, market listing approval, retail node certification, public-interest grant, RFP re-award, and BEINation transition. Each governance transition may generate a GovernanceTransitionReceipt bound to scope_hash, time_hash, policy_version, pre_state_digest, post_state_digest, and audit_anchor.

### BEIChip and Trusted Execution Inputs

A registration intent may originate from or be supported by a BEIChip, BEILogic, TimeChip, HSM, TEE, secure element, cloud enclave, or software-defined trusted execution boundary. A trusted event envelope may include identity reference, event digest, trusted time reference, nonce, policy hash, rollback boundary pointer, audit pointer, signature, and eligibility flags.

The registry may require trusted execution attestation for high-risk nodes such as root operators, ATMS nodes, healthcare nodes, governance nodes, market nodes, or financial routing nodes. A signed asset-state record may be used as a prerequisite for franchise, chain, retail, market, ATMS, index, or governance activation.

### BEI-TOT and BEI-SOS Fission Execution Layer

After registration, a BEI Operating Node may process admitted service events, product events, medical-health events, care events, franchise events, retail events, public-service events, licensing events, or asset-package events through a BEI-TOT or BEI-SOS fission execution layer. The layer may generate fission root records, derivative graph records, TimeCurrency records, BEI Currency records, index signals, license records, clearing records, grant records, and asset-package outputs.

The BEITLD registry remains the node-generation layer. Fission and derivative operations are downstream execution services bound to the registered node, its PolicyContainer, its root record, and its remediation boundary. This distinction avoids conflating node registration with event-value derivation while allowing both layers to interoperate through receipts and signed endpoints.

### NeedPack IndustryPack and Multi-Sector Deployment

The system supports NeedPack and IndustryPack registrations. NeedPacks may represent human, household, community, economic, health, education, housing, care, communication, service, governance, or emergency needs. IndustryPacks may represent finance, healthcare, education, logistics, energy, agriculture, retail, insurance, government, transportation, media, manufacturing, real estate, biomedical, IoT, and other industries.

Each Pack may reuse the same registration spine: intent envelope, BEDID or Doorplate, root record, NonDup gate, PolicyContainer, proof pipeline, ATMS route, index route, market route, governance route, and BEIFR2 boundary. Thus one core registration mechanism can support many domains without rewriting the machine workflow for each sector.

### EXAMPLES AND TECHNICAL EFFECTS

In a medical example, a clinic or MedicalCenter node may register a Time-Land-Resource Domain scope tied to a biomedical identity policy. The node may expose public service endpoints, private clinical proof endpoints, ATMS or grant routes, BEIIndex or health-value routes, and BEIFR2 correction procedures. A patient-facing lookup may return a privacy-filtered RRec, while a medical authority may receive additional proof fields under a scope token.

In a retail example, a chain operator may receive an RFP award and register a territory node. The territory node may spawn franchise nodes, which may spawn retail store nodes. Each store may receive a store doorplate, terminal endpoint set, settlement matrix, customer service endpoint, market listing eligibility, and remediation boundary. Transactions may be cleared through ATMS and indexed without allowing one store conflict to freeze unrelated stores.

Technical effects may include deterministic registration, race-condition reduction, non-duplicative allocation, evidence-based access control, proof-carrying resolution, atomic settlement routing, field-level privacy, bounded remediation, reduced blast radius, standards-version traceability, and improved interoperability among registry, identity, clearing, market, franchise, retail, and governance subsystems.

### ALTERNATIVE EMBODIMENTS

The system may operate as a private registry, public registry, enterprise registry, government registry, decentralized registry, hybrid registry, regional registry, healthcare registry, retail chain registry, digital land registry, or standards registry. A BEITLD record may be implemented as a DNS-compatible record, a signed endpoint record, a ledger record, a graph node, a relational database row, an object store entry, a credential, or a combination thereof.

Policy execution may be deterministic, rules-based, machine-learning-assisted, human-reviewed, or hybrid. AI may support classification, anomaly detection, translation, moderation, evidence scoring, route suggestion, and risk evaluation, while final registration state transitions may remain bound to policy versions and receipt artifacts. Embodiments may use cryptographic commitments, zero-knowledge proofs, threshold signatures, hardware attestation, multi-party computation, or privacy-preserving disclosure methods.

### CONCLUSION

The disclosed BEITLD registration operating system transforms registration from a passive name-record process into an active machine-controlled process for creating BEI Operating Nodes. By combining registration intent canonicalization, BEI Doorplate or BEDID allocation, Time-Land-Resource Root Records, NonDup/NonConflict/NonOverlap checks, executable PolicyContainers, proof artifacts, ATMS synchronization, value-state search, RFP and operator binding, franchise-chain-retail-market node classes, standards profiles, governance transitions, and BEIFR2 bounded remediation, the system provides a focused registration-origin component for a broader BEI infrastructure.

This registration-origin component is the main chain of the invention. Related BEI infrastructure layers may provide identity, trusted execution, clearing, fission, index, marketplace, medical, and security services, but the present disclosure centers on the machine process by which a BEI Time-Land-Resource Domain is registered and activated as a policy-governed operating node.

### Non Duplication Controller Algorithm and Reason Codes

The NonDup/NonConflict/NonOverlap controller executes a deterministic multi-index registry algorithm when a RegistrationIntentEnvelope is received. The controller derives label key by canonical normalization of the requested label, derives identity_key as a salted hash of the applicant identity anchor, derives time_key from the submitted time reference, and derives a nonduplication scope key from the requested Time-Land-Resource scope. The controller executes parallel lookups against a label index, identity index, time-window index, land-boundary index, resource index, territory index, franchise index, retail-node index, market-listing index, and policy-version index. The lookup results are compiled into a collision matrix. If a result is CONFLICT, DUPLICATE, PENDING, or HELD, the controller selects a highest-priority reason code and generates a denial receipt containing the reason code, collision matrix, intent digest, registry snapshot hash, and controller signature. If all dimensions are clear, the controller generates a NonDuplicationReceipt containing the intent digest, checked dimensions, all_clear flag, timestamp, and cryptographic seal.

Representative reason codes include: 0x0000 RC_SUCCESS; 0x4001 RC_LABEL_DUPLICATE; 0x4002 RC_IDENTITY_COLLISION; 0x4003 RC_TIME_WINDOW_OVERLAP; 0x4004 RC_LAND_SCOPE_OVERLAP; 0x4005 RC_RESOURCE_SCOPE_CONFLICT; 0x4006 RC_TERRITORY_CONFLICT; 0x4007 RC_FRANCHISE_OVERLAP; 0x4008 RC_RETAIL_NODE_CONFLICT; 0x4009 RC_MARKET_LISTING_DUPLICATE; 0x500A RC_POLICY_COLLISION; 0x500B RC_PENDING_LOCK; 0x6001 RC_STANDARDS_PROFILE_FAILURE; 0x7001 RC_REPLAY_OR_NONCE_FAILURE; and 0x8101 RC_BEIFR2_HOLD. The codes are machine-readable state-transition masks used to control registration, denial, hold, or remediation processing.

In one implementation, Algorithm NonDup.execute(RIE) comprises: compute intent_digest; compute nonduplication_scope_key; test pending locks; query each index for final records and pending records; construct collision_matrix; if any dimension is not clear, return denial_receipt(reason_code, collision_matrix, intent_digest); otherwise create NDR={ndr_id, intent_digest, checked_dimensions, all_clear, registry_snapshot_hash, ndr_timestamp, ndr_seal}; append the NDR to the proof chain; and release the request to root-record creation.

Each NonDup index may be implemented using a B-tree, hash table, interval tree for time and land or resource overlaps, geospatial tree, graph index, append-only accumulator, distributed ledger index, or another data structure that supports deterministic lookup, atomic compare-and-set, optimistic locking, or equivalent race-condition prevention for concurrent registration requests.

### Behavioral Economic Identity Feature Extraction

Behavioral Economic Identity (BEI) is represented as a machine-generated identity anchor and not merely as a conceptual personal identity. In embodiments requiring behavioral verification, a BehavioralExtractor receives an identity verification payload and extracts one or more feature values including credential digest, domain-origin event digest, time-anchor reference, transaction timing signatures, device interaction sequences, navigation pattern vectors, keystroke timing vectors, service participation history, settlement status, remediation state, governance-scope indicator, and policy eligibility state. Each feature value is normalized to a bounded numeric range and assembled into a behavioral_fingerprint_vector having a fixed dimensionality. In preferred embodiments the vector has at least 64 dimensions, and high-security embodiments may use 256 or more dimensions.

The system computes identity_anchor_hash=HASH(behavioral_fingerprint_vector∥identity_verification_payload_hash∥salt). The salt or equivalent secret may be stored in a hardware security module, trusted execution environment, secure element, or other protected key store. The identity_anchor_hash is stored in an IdentityAnchorRecord associated with a BEDID. Future NonDup or identity-collision checks may compare behavioral vectors using cosine similarity, Hamming distance, locality-sensitive hashing, secure multiparty comparison, or privacy-preserving threshold comparison. This provides an algorithmic definition of Behavioral Economic Identity suitable for registry operation while permitting privacy-protective implementations.

### Cryptographically-Chained Proof Artifact Pipeline

The proof artifact pipeline is an ordered chain in which each artifact includes or references a cryptographic hash of the preceding artifact. A representative chain comprises: RegistrationIntentEnvelope; DoorplateBindingRecord generated on BEDID allocation; BEITLDRootRecord generated upon root-record creation; PolicyContainer bound to the root record; NonDuplicationReceipt generated by the NonDup controller; ResolutionReceipt generated on final registration authorization; AuthorizationClearingReceipt generated on ATMS authorization; and FinalityMarker generated as the terminal activation artifact. A RollbackProof or BEIFR2 Remediation Record may later be generated from the FinalityMarker when bounded remediation is authorized.

The FinalityMarker is a machine-readable terminal activation object and may include fm_id, root_record_id, node_state, proof_root_hash, audit_anchor, atms_pointer, beimarket_pointer, beigdp_pointer, beifr2_boundary, state_transition_log, cryptographic_seal, and fm_timestamp. The proof_root_hash may be a Merkle root of hashes of the registration envelope, doorplate binding record, root record, PolicyContainer, NDR, ResolutionReceipt, and ACR. The FinalityMarker thereby provides a verifier-reconstructable proof that the registered node passed the ordered registration-origin pipeline.

### BEIFR2 Blast-Radius Bounded Remediation Algorithm

Before any remediation action is executed, the BEIFR2 subsystem computes a blast radius. The system retrieves the root record for the trigger node, builds a dependency graph including child franchise nodes, chain nodes, retail nodes, service nodes, active ATMS routes, market listings, unresolved remediation holds, and data-room references that depend on the trigger node. The subsystem traverses the dependency graph to identify an affected_node_set and derives an unaffected_node_set. The requested rollback scope is tested against each affected node PolicyContainer and BEIFR2 boundary. If a node prohibits the requested rollback or exceeds a quantitative bound, the subsystem generates a remediation rejection or hold code.

For affected nodes within the permitted boundary, the subsystem may freeze ATMS routes, pause market listings, preserve proof chains, mark affected states as REMEDIATION_PENDING, restore valid pre-trigger snapshots, generate post-remediation FinalityMarkers, and create a BEIFR2RemediationRecord comprising remediation_id, trigger_node_id, affected_node_set, unaffected_node_set_hash, pre_state_snapshot_hash, post_state_hash, blast_radius_digest, policy_authorization_hash, bounded_proof, receipt_signature, and remediation_timestamp. Quantitative boundaries may include maximum rollback depth, maximum value-at-risk, maximum node count, maximum dependency depth, required authorization threshold, and time-window limits.

### BEIGDP Node Value Record Computation

A BEIGDP or BEIIndex route may generate a node-value data record from machine-readable registry states. In one embodiment, the engine retrieves a root record and computes component scores comprising identity_anchor_strength, time_seniority, proof_completeness, ATMS normalized balance or activity score, and market comparables score. A node_value_score may be computed as a weighted sum of component scores, for example w1*identity_anchor_strength+w2*time_seniority+w3*proof_completeness+w4*ATMS_activity_score+w5*market_comparables_score, wherein the weights are stored in a standards profile or PolicyContainer. A confidence interval or quality flag may be computed from the available data.

The BEIGDPRecord is a technical registry output comprising beigdp_id, node_id, node_value_score, component_breakdown, confidence_interval, computation_timestamp, standards_profile_id, prior_beigdp_id, and cryptographic seal. A BEIGDPRecord is a machine-readable index record and is not, by itself, an investment opinion, income guarantee, or promise of financial value.

### Representative Data Objects

REGISTRATION INTENT ENVELOPE SCHEMA

| Field | Type | Description |
|---|---|---|
| envelope_id | UUID | Unique envelope identifier |
| applicant_bedid | String or hash | Applicant BEI Doorplate or BEDID |
| applicant_identity_anchor | Hash | Merkle or equivalent identity anchor |
| requested_label | String | Normalized requested label |
| time_scope | Interval | Start and end time coordinates |
| land_scope | Boundary descriptor | Spatial or land/resource boundary |
| resource_scope | Class descriptor | Resource class or object class |
| node_class | Enum | Base, territory, franchise, chain, retail, |
| | | market, medical, ATMS, index, |
| | | governance, resolver, data-room, or |
| | | sector |
| evidence_digest | Hash | Digest of submitted evidence |
| policy_template_id | Identifier | Policy template or pointer |
| signature_set | Array | Applicant and authority signatures |
| nonce | Integer | Anti-replay counter |

BEITLD ROOT RECORD SCHEMA

| Field | Type | Description |
|---|---|---|
| root_record_id | UUID | Primary root record identifier |
| canonical_label_hash | Hash | Deterministic canonical label key |
| bedid | String | Bound BEI Doorplate identifier |
| node_class_bitmask | Integer | Encoded node class or class set |
| boundary_coordinates | Bytes or JSON | Compressed time-land-resource |
| | | boundary |
| parent_root_id | UUID | Parent node pointer |
| policy_container_id | UUID | Executable PolicyContainer reference |
| signed_endpoint_set | Array | Signed endpoint references |
| proof_root | Hash | Root of proof artifact chain |
| atms_route_id | UUID | ATMS route identifier |
| finality_marker_id | UUID | Terminal Finality Marker reference |
| lifecycle_state | Enum | Reserved, queued, active, suspended, |
| | | remediated, transferred, expired, or |
| | | archived |

POLICYCONTAINER SCHEMA

| Field | Type | Description |
|---|---|---|
| container_id | UUID | PolicyContainer identifier |
| version_id | Integer | Version identifier |
| eligibility_bitmask | Integer | Permitted checks and roles |
| disclosure_rules | Object | Public and scope-token disclosure |
| | | masks |
| territory_rules | Object | Territory and expansion permissions |
| franchise_rules | Object | Franchise grant, royalty, termination, |
| | | and quality rules |
| retail_rules | Object | Retail and service node creation |
| | | permissions |
| market_rules | Object | Market listing and data-room |
| | | constraints |
| atms_settlement_parameters | Object | Clearing route, royalty basis, currency |
| | | class, settlement matrix |
| birstdsec_profile | Identifier | Standards and practice profile |
| beifr2_boundary | Object | Rollback depth, value-at-risk, node |
| | | count, and authorization threshold |
| | | limits |

FINALITYMARKER FIELD TABLE

| Field | Type | Description |
|---|---|---|
| fm_id | UUID | Globally unique FinalityMarker |
| | | identifier |
| root_record_id | UUID | Reference to BEITLD Root Record |
| node_state | Enum | ACTIVE, SUSPENDED, |
| | | REMEDIATED, TRANSFERRED, |
| | | EXPIRED, or ARCHIVED |
| proof_root_hash | Hash | Merkle root of proof artifact hashes |
| audit_anchor | Timestamp signature | Trusted time authority or equivalent |
| | | signature over proof_root_hash |
| atms_pointer | UUID or URI | Reference to ATMS endpoint or record |
| beimarket_pointer | UUID or URI | Reference to BEIMarket listing record |
| beigdp_pointer | UUID or URI | Reference to BEIGDP or BEIIndex |
| | | record |
| beifr2_boundary | Object | Bounded remediation scope |
| state_transition_log | Append-only array | Prior state, new state, trigger, authority |
| | | hash, timestamp |
| cryptographic_seal | HMAC or signature | Seal over FinalityMarker fields |
| fm_timestamp | Timestamp | Immutable generation timestamp |

NONDUPLICATIONRECEIPT FIELD TABLE

| Field | Type | Description |
|---|---|---|
| ndr_id | UUID | Globally unique NDR identifier |
| intent_digest | Hash | Digest of RegistrationIntentEnvelope |
| checked_dimensions | Array | At least label, identity, time, |
| | | land/resource, territory, franchise, retail, |
| | | market, policy |
| all_clear | Boolean | True only if all dimensions are clear |
| collision_log | Array | Collision dimension, conflicting record, |
| | | reason code |
| registry_snapshot_hash | Hash | Snapshot or accumulator proof |
| ndr_timestamp | Timestamp | Generation time |
| ndr_seal | HMAC or signature | Seal over all NDR fields |

BEIFR2 REMEDIATION RECORD FIELD TABLE

| Field | Type | Description |
|---|---|---|
| remediation_id | UUID | Remediation identifier |
| trigger_node_id | String | Node triggering remediation |
| trigger_code | Enum | Duplicate, identity error, fraud, order, |
| | | policy error, governance decision |
| affected_node_set | Array | Nodes within blast radius |
| unaffected_node_set_hash | Hash | Proof that unaffected nodes remain |
| | | outside blast radius |
| pre_state_snapshot_hash | Hash | Pre-remediation snapshot |
| post_state_hash | Hash | Post-remediation state |
| blast_radius_digest | Hash | Dependency graph digest |
| policy_authorization_hash | Hash | Authorization under PolicyContainer |
| bounded_proof | Object | Proof that affected_node_set is within |
| | | BEIFR2 boundary |
| receipt_signature | Signature | Remediation authority signature |
| remediation_timestamp | Timestamp | Execution time |

### Representative Worked Examples

### Franchise Node Registration and Activation Flow

An RFP-selected franchise operator submits a RegistrationIntentEnvelope specifying node_class=franchise, requested territory_scope, franchisee_bedid, evidence digest, and selected policy template. The registry canonicalizes the requested scope, computes an intent digest and nonduplication scope key, and evaluates label, identity, territory, franchise hierarchy, retail expansion, and policy conflicts. Upon allowance, the registry creates a BEITLD Root Record, injects a PolicyContainer defining royalty basis, ATMS route, sub-node permissions, and BEIFR2 quantitative boundaries, activates the Franchise Operating Node through reserved, checked, policy_bound, root_created, proof_generated, and active states, generates RRec, NonDuplicationReceipt, ACR, FinalityMarker, and exposes signed endpoints for retail sub-node creation, market listing eligibility, and bounded remediation. All state transitions are receipt-bound and verifier-reconstructable.

Retail Store Node Spawning from Parent Franchise Node

A franchisor operating an active Franchise Node submits a child-node request for a new retail store within an authorized territory. The system validates that the parent PolicyContainer permits retail-node creation, performs scoped NonDup and overlap checks focused on retail-node conflicts, territory overlap, active market listings, and service-area collisions, creates a child BEITLD Root Record linked to the parent, injects a retail-specific PolicyContainer or inherits permitted portions of the parent PolicyContainer, provisions store doorplate, terminal endpoints, customer-service endpoints, and ATMS routes, activates the Retail Operating Node, and generates a separate proof chain and remediation boundary. A remediation action on the child node does not automatically affect unrelated sibling or parent nodes outside the computed dependency graph.

Medical or Healthcare Node with Privacy and Standards Binding

A licensed medical provider registers a MedicalCenter node with node_class=medical and attaches licensing evidence, privacy tier, health-service scope, and a BIRSTDSEC-compliant policy template. The system performs multi-dimensional NonDup evaluation including identity, territory, standards profile, service-scope, and policy-version dimensions, creates a BEITLD Root Record, injects a PolicyContainer that enforces field-level privacy filtering and scope-token access, binds the applicable standards profile, activates the node, and generates proof artifacts including compliance receipts. Public lookups return privacy-filtered Resolution Receipts, while authorized parties may receive additional proof fields under scope-token control. BEIFR2 remediation actions respect both technical bounds and healthcare policy constraints encoded in the PolicyContainer.

### Implementation Detail 1: Pre-Registration Search and Availability

The search engine receives a human-readable name, BEI Doorplate request, resource class, time coordinate, land coordinate, industry category, or market scope and returns a value-state result rather than a bare availability result. The result may include public availability, conditional availability, reserved status, conflict status, remediation status, and an RRec.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 2: Reserved Label and Public Interest Rules

A reserved-label module may protect public-interest terms, regulatory terms, medical terms, governmental terms, emergency-service terms, root BEI terms, standards terms, and previously reserved identifier reservoir terms. A registration may proceed only under a policy route or RFP award.

A ReservedLabelRecord may include label_hash, reservation_class, authorized_policy_routes, rfp_required, reservation_expiry, and governance authority. A request is denied with RC_LABEL_RESERVED unless the applicant provides a valid RFP award, policy route, or authority signature. The record is versioned and protected by threshold signature.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 3: Pending Locks and Race Control

A pending lock may be created during registration review. The lock includes intent_digest, applicant reference, requested scope, expiration, policy version, and collision index reference. Race control prevents duplicate or overlapping root records from being finalized during concurrent submissions.

A PendingLock object may include lock_id, intent_digest, applicant_bedid, requested_scope_hash, expiration, policy_version, and collision_index_reference. The lock store uses atomic compare-and-set or optimistic concurrency control. A request that collides with an active lock receives RC_PENDING_LOCK and a denial or hold receipt identifying the conflicting lock and expiration time.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 4: Operator Eligibility

An operator eligibility module may evaluate identity proof, role credentials, capacity evidence, RFP score, compliance history, governance approvals, and technical integration readiness. The output may be a signed eligibility state used by the PolicyContainer.

OperatorEligibilityRecord may include operator_bedid, role_class, RFP score, license evidence, compliance state, technical capacity score, jurisdiction, public-service authority, and revocation status. The PolicyContainer maps these fields to an eligibility bitmask and generates an operator-eligibility receipt.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 5: Node Lifecycle Ledger

A lifecycle ledger records reserved, pending, active, delegated, franchised, chained, retail-enabled, market-listed, suspended, frozen, remediated, transferred, archived, or retired states. Each transition may be linked to a receipt and audit anchor.

Lifecycle transitions are executed through a NodeLifecycleStateMachine. Each transition requires a trigger, authority hash, prior state, new state, policy version, proof root, timestamp, and transition receipt. Disallowed transitions generate a reason code rather than silently changing state.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 6: Franchise and Chain Scope

The registry may store a franchise_scope defining field-of-use, territory, time, industry, service classes, brand rules, revenue sharing, quality controls, termination rules, and remediation boundaries. Chain nodes aggregate branch and retail nodes while preserving local state isolation.

A FranchiseScopeRecord may include franchisor_bedid, franchisee_bedid, territory_scope, industry_scope, allowed child node classes, royalty basis, quality-control rule, termination condition, ATMS route, and BEIFR2 boundary. Franchise overlap is evaluated by the NonDup controller before activation.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 7: Retail Store and Service Node Deployment

A retail or service node may include customer-facing endpoints, service catalogs, terminal devices, ATMS payment routes, privacy disclosures, receipts, and customer-service policy. The node may be online, physical, hybrid, mobile, household-based, or agent-operated.

A RetailNodeRecord may include parent_node_id, store_doorplate, retail_location_scope, service_area, terminal_endpoint_set, ATMS payment route, customer-service endpoint, inventory or service category, privacy notice reference, and remediation boundary. The child record inherits selected policy fields from the parent and maintains a separate proof chain.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 8: Market and Data Room Listing

A market listing may expose a license field, transfer condition, royalty basis, data-room pointer, proof-artifact set, patent-family pointer, domain-asset pointer, and remediation status. Listings may be public, private, invited, staged, or regulator-viewable.

A MarketListingRecord may include listing_id, root_record_id, license_field, transfer_condition, royalty_basis, data_room_pointer, proof_artifact_set, patent_family_pointer, domain_asset_pointer, standards profile, and remediation status. The listing is generated only after FinalityMarker validation and policy authorization.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 9: Governance and BEINation Transition

A registered node may transition into regional, industry, or nation-level governance states. Governance receipts may record voting thresholds, authority scope, standards versions, policy modules, treasury routes, and revocation states.

A GovernanceTransitionRecord may include prior_governance_state, new_governance_state, authority_digest, voting_threshold, standard_version, effective time window, affected node set, and remediation route. Governance updates are bound to proof artifacts to prevent untraceable rule changes.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 10: Standards and Practice Binding

BIRSTDSEC or related standards profiles may be bound to node classes. Standards binding makes it possible to test whether a registrar, operator, franchisee, market participant, or clearing node complies with defined machine-readable practice rules.

A StandardsProfileRecord may include schema_version, required fields, algorithm identifiers, signature requirements, audit retention period, privacy filtering rule, reason-code taxonomy, dispute route, and remediation boundary. The profile may be referenced by the PolicyContainer and FinalityMarker.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 11: MedicalCenter Node Example

A MedicalCenter node may register clinical service scope, patient privacy levels, biomedical identity anchors, health-grain record routes, grant or insurance routes, and BEIFR2 correction rules for erroneous or disputed evidence.

A MedicalNodeRecord may include licensing evidence digest, healthcare service class, privacy tier, scope-token policy, standards profile, regulator access route, insurance or grant route, and BEIFR2 privacy-safe remediation boundary. Sensitive fields are disclosed only under scope-token access.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation on Detail 12: Education Node Example

An education node may register courses, credentials, learning behavior evidence, time credits, teacher or institution identity, and proof-based settlement for scholarships, grants, or learning-unit rewards.

An EducationNodeRecord may include institution BEDID, course scope, credential schema, learning evidence digest, teacher identity anchor, grant or scholarship route, privacy policy, and proof-chain pointer. Completion, renewal, and revocation events generate receipt-bound state transitions.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 13: IoT and Device Node Example

An IoT node may register a device or sensor fleet, bind device identifiers to BEI Doorplates, record trusted execution inputs, and route device events to ATMS, BEIIndex, or remediation services.

An IoTNodeRecord may include device fleet identifier, device attestation digest, sensor class, endpoint route, trusted execution reference, event stream hash, rate limit, and remediation trigger conditions. Device events may be admitted only after signature, nonce, and PolicyContainer checks.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 14: Real Estate and Land Resource Example

A land-resource node may register parcels, leases, mortgage states, IoT sensor feeds, maintenance receipts, settlement references, audit anchors, and remediation boundaries for property-related disputes or status changes.

A LandResourceNodeRecord may include parcel descriptor, lease state, mortgage or pledge state, IoT sensor feed digest, maintenance receipt route, settlement reference, public record pointer, and remediation boundary. Spatial overlap queries are executed through the land boundary index.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 15: Public-Service and Emergency Example

A public-service node may expose emergency, care, health, aid, energy, water, safety, or response endpoints. Policy may prioritize access, field-level disclosure, public-interest use, and correction authority.

A PublicServiceNodeRecord may include service class, emergency access policy, priority flag, authority digest, public-interest scope, privacy rule, and resilience route. The PolicyContainer may permit emergency access while still generating Resolution Receipts and audit anchors.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 16: International and Legacy Interoperability

The system may interoperate with existing registrars, DNS, RDAP, payment rails, bank rails, digital identity systems, smart contracts, APIs, regulatory reporting systems, and data-room platforms while preserving BEITLD proof and policy semantics.

ExternalInfrastructureAdapter records may bind business formation records, registered-agent records, conventional registrar records, RDAP records, bank-rail acknowledgments, regulator reports, or industry-operator credentials to a BEITLD root record through scope tokens, policy rules, and proof artifacts.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 17: Security Model

Security features may include signature chains, replay protection, audit-before-finality, threshold approvals, hardware attestation, policy-version binding, append-only logs, zero-knowledge disclosure, receipt dependency graphs, and bounded blast-radius remediation.

Security processing may include nonce verification, replay filters, signature-chain validation, policy hash comparison, HSM or TEE attestation, zero-knowledge proof verification, threshold authorization, and append-only audit logging. Failed checks are expressed as reason codes and denial receipts.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 18: No Financial Promise

The system may create data structures for ATMS, BEI Currency, TimeCurrency, BEIGDP, BEIIndex, and market records. Such structures are technical outputs and do not by themselves guarantee financial returns, legal-tender status, market value, regulatory approval, or transaction completion.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 19: Claim Support and Ordered Combination

The ordered combination of registration intent canonicalization, BEI Doorplate binding, Time-Land-Resource root record creation, NonDup/NonConflict/NonOverlap gating, executable PolicyContainer injection, proof artifact generation, and operating-node activation provides a specific machine process distinct from conventional domain registration.

The ordered combination is not a mere aggregation. The output of each stage becomes a required input to the next stage: canonicalization produces an intent digest; NonDup produces NDR or denial; root record creation binds BEDID and scope; PolicyContainer injection constrains activation; proof pipeline creates FinalityMarker; FinalityMarker activates downstream routes and remediation boundaries.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Implementation Detail 20: Registrar-Grade Implementation

A production implementation may expose registrar-like user interfaces for search, application, review, cart, payment, registration, receipt download, renewal, transfer, lock, listing, and support. Internally, each user action is transformed into policy-bound machine records and proof artifacts.

The user-facing interface may resemble a registrar, but the back-end machine output differs. The registrar interface outputs not only a name record but also a root record, PolicyContainer binding, proof chain, FinalityMarker, ATMS route, market route, index route, and BEIFR2 boundary, each recorded as a structured data object.

In some embodiments, the registry stores the relevant state as an object graph rather than as a single flat record. Parent and child nodes may inherit policy, standards, remediation boundaries, and settlement routes. Modified child policies may be permitted only where the parent PolicyContainer allows deviation and the resulting state passes NonDup/NonConflict/NonOverlap evaluation.

The implementation may produce a receipt at each material step. The receipt allows a verifier to recompute the relevant digest, check policy version, confirm the audit anchor, identify the reason code, and determine whether a later correction is bounded to an affected node set. This stepwise proof construction supports examination under the written description, enablement, and patent-eligibility requirements by describing concrete data structures and state transitions.

### Related Infrastructure Mapping for Claim Support

The following mapping is provided as a technical coordination guide. Formal domestic benefit or priority relationships must be set forth in the ADS. The table identifies how related BEI infrastructure layers may support embodiments without converting the present application into a mere aggregation of prior disclosures.

### Appendix Implementation Page—Registrar Interface and Back-End Separation

A user-facing registrar interface may present ordinary steps such as search, apply, review, pay, register, renew, transfer, lock, list, and support. The back-end registry, however, converts each step into canonical machine records. This separation permits familiar user operation while preserving the technical BEITLD proof, policy, and remediation spine.

### Appendix Implementation Page—Availability Search Data Fields

A BEITLD search result may include availability_state, conditional_state, policy_gate, nondup_score, competing_pending_lock, public_interest_hold, required_RFP_route, expected_node_class, estimated_ATMS_route, and disclosure_level. These fields improve traditional search because the system evaluates operating-node eligibility rather than only string availability.

### Appendix Implementation Page—Application Intake Validation

The intake module may reject incomplete envelopes before registry locking. Required fields may include identity anchor, requested scope, node class, time reference, evidence digest, signature set, policy template, and applicant role. Optional fields may include RFP record, territory request, franchise request, market listing preference, and trusted execution evidence.

### Appendix Implementation Page—Canonicalization and Digest Reproducibility

The canonicalization engine may normalize label case, language encoding, time units, land units, resource descriptors, policy version identifiers, and signature set order. A verifier can reproduce the intent digest from the envelope and verify that later receipts bind to the same intent.

### Appendix Implementation Page—Identifier Reservoir Integration

In some embodiments, a curated identifier reservoir originating from earlier BEI namespace resources supplies basepoints for persons, families, industries, countries, regions, objects, services, stores, devices, and public functions. The registry may allocate derived identifiers without exhausting the reservoir because child nodes carry scoped identifiers.

### Appendix Implementation Page—Doorplate Allocation Policy

Doorplate allocation may depend on class, capacity, scope, nondup result, public-interest status, RFP award, privacy preference, jurisdictional rule, or standards profile. The registry may reserve special doorplates for root governance, emergency services, medical services, clearing services, or standards bodies.

### Appendix Implementation Page—PolicyContainer Execution Semantics

A PolicyContainer may be represented as a ruleset, smart contract, decision table, signed JSON object, executable code module, or deterministic policy graph. The container may specify which state transitions are automatic, which require review, and which require multi-signature or governance approval.

### Appendix Implementation Page—Proof-First Registration Commit

The registry may require proof artifacts to be generated before final external publication. For example, the system may generate an RRec and NonDuplicationReceipt before creating an active signed endpoint, and may generate a FinalityMarker before ATMS synchronization or market listing.

### Appendix Implementation Page—Privacy-Filtered Public Record

The public BEITLD record may disclose only a subset of fields. Sensitive identity, medical, financial, location, or franchise information may remain hidden behind scope-token access. The public record may still expose enough hash references to allow auditors to verify existence and integrity.

### Appendix Implementation Page—Renewal Lifecycle

Renewal may require policy revalidation, standards-profile update, ATMS fee confirmation, identity status check, nondup recheck for expanded scope, and receipt generation. The renewal receipt may bind old and new policy versions and preserve continuity of the root record.

### Appendix Implementation Page—Transfer Lifecycle

A transfer may require transferor BEDID, transferee BEDID, signed authorization, policy approval, unpaid fee check, remediation hold check, and reissue of endpoint records. A transfer may update operator state without destroying historical receipts.

### Appendix Implementation Page—Delegation and Subnode Creation

A parent_node may delegate child node creation only within policy boundaries. A territory node may create franchise nodes; a franchise node may create retail nodes; a market node may create listing nodes. Each child node has its own proof chain and remediation boundary.

### APPENDIX IMPLEMENTATION PAGE—SUSPENSION AND REINSTATEMENT

Suspension may restrict endpoints, market listing, ATMS settlement, or subnode creation. Reinstatement may require reason-code clearance, compliance proof, debt resolution, governance decision, or remediation receipt. The process preserves audit trails and avoids silent deletion.

### Appendix Implementation Page—Market Eligibility Gate

Before a node enters BEIMarket, the system may verify root record finality, policy version, ownership, license field, data-room pointer, proof set, remediation state, and standards compliance. Market listing eligibility is a state derived from technical records, not merely a commercial decision.

### Appendix Implementation Page—Franchise Royalty Basis

A franchise node may carry a royalty basis formula, settlement route, reporting period, audit rule, and territory constraint. The registry may route royalty records through ATMS and generate receipts to show whether downstream retail nodes are within authorized scope.

### Appendix Implementation Page—Retail Terminal Binding

Retail terminals may be bound to store doorplates and endpoint records. A terminal may sign transactions, cache offline events, synchronize ordered intents, and receive confirmation receipts. A compromised terminal may be isolated without revoking the entire chain.

### Appendix Implementation Page—Offline Operation

Offline operation may be permitted for retail, medical, field-service, or public-service nodes. Cached intents may be hash-chained locally and submitted later. The registry or ATMS layer verifies sequence, nonce, policy version, and terminal signature before final settlement.

### Appendix Implementation Page—Medical Privacy Boundary

Medical implementations may use patient, provider, facility, device, and service scope tokens. The BEITLD record may reveal node existence while hiding clinical details. Authorized parties may receive selected proof fields under policy containers and audit commitments.

### Appendix Implementation Page—Public Sector Node

A public-sector node may support permits, benefits, emergency response, education, energy, health, or infrastructure services. Public-interest policies may override ordinary market listing or franchise rules, but all transitions remain receipt-bound.

### Appendix Implementation Page—Land and Resource Boundary Encoding

Land and resource boundaries may be expressed as coordinates, parcel identifiers, service zones, asset inventories, legal descriptions, digital land descriptors, or resource-class IDs. The NonOverlap controller normalizes such data before comparing overlaps.

### Appendix Implementation Page—Time Scope Encoding

Time scope may include Time-of-Time coordinates, calendar windows, service periods, lease periods, renewal intervals, event timestamps, custody periods, or operational windows. The registry may reject overlapping time scopes where the policy forbids simultaneous operation.

### Appendix Implementation Page—Resource Scope Encoding

Resource scope may include physical resources, digital resources, service resources, data resources, rights bundles, licenses, terminals, stores, medical services, public utilities, or market listings. Policy rules determine whether scopes can overlap or must be exclusive.

### Appendix Implementation Page—BEI GDP and Index Safety

Index routes may publish technical state and computed metrics but do not guarantee legal or financial value. The index record is a verifiable data object that records inputs, proof references, algorithm profile, and output route for downstream analysis.

### Appendix Implementation Page—Data Room Completeness

A data-room record may contain the minimum package necessary for technical diligence: root record, policy version, proof artifacts, state history, related patents, domain assets, market records, standards profile, risk notes, and remediation status.

### Appendix Implementation Page—Cip Family Role

Related applications may support underlying modules, but the present application focuses on the registration-origin layer. The distinction helps preserve a focused claim scope while allowing embodiments to integrate identity, clearing, fission, trusted execution, and remediation infrastructure.

### Appendix Implementation Page—102 and 103 Distinction

Conventional registrars, DID systems, DNS resolvers, blockchain naming systems, payment systems, and marketplace systems do not teach the ordered combination in which a registration request creates a BEDID-bound time-land-resource operating node with policy container, proof artifacts, ATMS route, node class, and bounded remediation boundary.

### Appendix Implementation Page—101 Technical Improvement

The disclosed system improves computer registry operation by adding deterministic canonicalization, multi-dimensional conflict checking, proof-carrying state transitions, field-level privacy, receipt-based verifier reconstruction, and bounded remediation. These are concrete computing operations, not merely business rules.

### Appendix Implementation Page—112 Written Description Support

The specification identifies representative data objects, fields, state machines, reason codes, proof artifacts, node classes, endpoints, and remediation records. These details provide support for implementation and for distinguishing the claimed registry transformation from abstract economic concepts.

### Appendix Implementation Page—Claim 1 Central Spine

Independent claim 1 should remain focused on the registration spine: receive envelope, canonicalize scope, bind Doorplate or BEDID, execute NonDup/NonConflict/NonOverlap, create root record, inject PolicyContainer, activate node, generate proof artifacts, and expose endpoints.

### Appendix Implementation PAGE—METHOD CLAIM CENTRAL SPINE

The method claim should mirror the machine process and avoid unnecessary business promises. Each step should be performed by processors and should produce a machine-readable state, receipt, or endpoint.

### Appendix Implementation Page—Computer-Readable Medium Spine

The medium claim protects software implementation of the registry operating system, including instructions for canonicalization, nonduplication, policy injection, node activation, proof generation, endpoint exposure, and bounded remediation.

### Appendix Implementation Page—Draw Ing Support

The drawings collectively show the architecture, workflow comparison, data structures, NonDup gate, PolicyContainer, lifecycle, proof chain, BEIDNS layer, RFP conversion, franchise-chain-retail-market classes, ATMS integration, index routing, BEIFR2, standards binding, trusted execution, fission layer, and asset-package map.

Appendix Implementation Page—Implementation without Single Vendor Dependence

The system may be operated by one entity, multiple registry operators, regional operators, industry operators, public agencies, private companies, or decentralized networks. The technical record format allows interoperability across different administrative arrangements.

### Appendix Implementation Page—Avoiding Overbroad Commercial Claims

Commercial possibilities such as licensing, valuation, market listing, or asset-package use are implemented through records, proof artifacts, and routes. The claims need not assert guaranteed revenue or market control to protect the technical registration transformation.

### Appendix Implementation Page—Node-to-Node Interoperability

A registered node may discover another node through signed endpoint records and RRec verification. Interoperability may be denied, limited, or allowed according to policy and scope token. This permits safe cooperation among franchise, market, clearing, medical, and public nodes.

### Appendix Implementation Page—Regulatory and Standards Adapters

Adapters may map BEITLD records to conventional domain registries, business registries, payment rails, government portals, standards bodies, market systems, and audit platforms. The adapter preserves the BEI proof spine while translating outward-facing data.

### Appendix Implementation Page—Final Registration Output

The final registration output may include the root record, DoorplateBindingRecord, operating-node record, signed endpoints, policy container, proof artifact set, ATMS route, index route, market eligibility, governance status, and remediation boundary. This output is the core product of the claimed system.

### Appendix Implementation Page—Best Mode Currently Contemplated

A preferred implementation uses a web-based registrar interface, registry server, resolver gateway, identity service, NonDup index, policy execution service, proof ledger, ATMS connector, BEIMarket connector, standards profile store, and BEIFR2 remediation service. Each component communicates through signed messages and canonical record schemas.

### Appendix Implementation Page—Closing Statement

The invention is centered on one main chain component: registration-origin activation of BEI Time-Land-Resource Domain operating nodes. The family infrastructure may be large, but the claimed core remains the registrar-like machine pathway that converts a request into an enforceable, proof-bearing, policy-governed operating node.

### Supplemental Implementation Support and Claim Correlation

The following supplemental implementation support further describes the same registration-origin transformation already disclosed above: a BEI registration request is converted into an active, proof-carrying, policy-governed BEI Operating Node. The additional material is provided to support enablement, written description, verifier reconstruction, drawing reference numerals, and claim-to-element mapping without changing the registration-first focus of the invention.

Each subsection identifies machine inputs, registry processing steps, data objects produced, and output artifacts. The descriptions may be used independently or together in various embodiments, but the preferred ordered pipeline remains: RegistrationIntentEnvelope, canonicalization, multidimensional NonDup gate, Doorplate or BEDID binding, BEITLD Root Record creation, PolicyContainer injection, proof artifact generation, FinalityMarker issuance, ATMS/market/index activation, and BEIFR2 bounded remediation.

The system may be implemented as a cloud registry service, enterprise registry cluster, hybrid public-private registry, sovereign domain registry, healthcare registry, retail-franchise registry, or API-based registry service. In each case, the same technical objects and algorithms may be used even if commercial deployment, governance identity, jurisdiction, fee schedule, or user interface differs.

### Claim Element Support Index

Claim 1 special-purpose registry machine: Supported by the ordered registry pipeline, data object schemas, NonDup algorithm, proof pipeline, FinalityMarker field table, and Operating Node lifecycle state machine. The machine transforms an input registration intent into an active node rather than a passive name record.

Claim 1 registration intent envelope: Supported by the RegistrationIntentEnvelope schema including applicant_bedid, identity anchor, scope fields, node class, evidence digest, policy template, signature set, and nonce. The envelope provides a reproducible canonical input to the registry machine.

Claim 1 canonicalization: Supported by canonical normalization of labels, encoding, time units, land or resource descriptors, policy identifiers, and signature order. Canonicalization produces an intent digest and nonduplication scope key that are used by later stages.

Claim 1 BEI Doorplate or BEDID binding: Supported by DoorplateBindingRecord and identity anchor hash. The binding associates the applicant or operator identity with the requested Time-Land-Resource scope and becomes a predecessor artifact in the proof pipeline.

Claim 1 multidimensional NonDup controller: Supported by NonDup.execute, collision matrix construction, pending lock processing, reason-code taxonomy, NonDuplicationReceipt field table, and multi-index queries across label, identity, time, land/resource, territory, franchise, retail, market, and policy dimensions.

Claim 1 BEITLD root record: Supported by the BEITLDRootRecord schema, root_record_id, canonical label hash, BEDID, node class, scopes, parent pointer, policy container reference, signed endpoints, proof root, route identifiers, lifecycle state, and timestamp.

Claim 1 PolicyContainer injection: Supported by the PolicyContainer schema, version binding, eligibility rules, disclosure rules, territory and franchise rules, ATMS settlement parameters, standards profile, governance rights, revocation rules, and BEIFR2 boundary.

Claim 1 Operating Node activation: Supported by the lifecycle state machine, node class taxonomy, state-transition log, FinalityMarker data object, and examples for franchise, retail, medical, public-service, IoT, and land-resource nodes.

Claim 1 proof artifacts: Supported by the cryptographically chained proof pipeline including RegistrationIntentEnvelope, DoorplateBindingRecord, BEITLDRootRecord, PolicyContainer, NDR, ResolutionReceipt, ACR, FinalityMarker, and optional RollbackProof.

Claim 1 FinalityMarker activation pointers: Supported by the FinalityMarker field table including ATMS pointer, BEIMarket pointer, BEIGDP or BEIIndex pointer, BEIFR2 boundary, proof_root_hash, audit_anchor, and state-transition log.

Claim 2 node classes: Supported by node class field requirements for base, territory, RFP operator, franchise, chain, retail, market, medical, ATMS, index, governance, resolver, data-room, and sector nodes.

Claim 3 BEIRFP conversion: Supported by RFP intake, applicant scoring, operator BEDID, territory scope, authority marker, and RFP-to-BEITLD registration intent envelope processing.

Claim 4 reason codes: Supported by numerical and textual reason-code taxonomy, including duplicate, collision, overlap, pending lock, standards failure, replay, and BEIFR2 hold codes.

Claim 5 root record fields: Supported by the formal root record schema and versioned hash chain enabling verifier reconstruction.

Claim 6 PolicyContainer fields: Supported by the formal PolicyContainer schema and execution semantics that bind registration, disclosure, settlement, governance, standards, and remediation rules.

Claim 7 lifecycle states: Supported by the NodeLifecycleStateMachine and state-transition log; each transition includes trigger, authority hash, prior state, new state, policy version, proof root, and timestamp.

Claim 8 Resolution Receipt: Supported by the Resolution Receipt description including result or denial, reason code, policy hash, policy version, scope-token digest, revocation reference, rollback reference, TTL, audit anchor, and signature chain.

Claim 9 ATMS clearing integration: Supported by deterministic clearing kernel references, namespace address resolution, hierarchical account graph, canonical transaction hash, nonce anti-replay gate, settlement matrix, and verifier proof set.

Claim 10 franchise/chain/retail/market nodes: Supported by FranchiseScopeRecord, RetailNodeRecord, MarketListingRecord, child node inheritance, separate proof chains, royalty basis, ATMS route, and remediation boundaries.

Claim 11 BEIFR2 bounded remediation: Supported by blast-radius computation, dependency graph, affected_node_set, unaffected_node_set_hash, quantitative boundaries, authorization threshold, remediation record, and post-remediation FinalityMarker generation.

Claims 12-20 method and computer-readable medium: Supported by the same ordered pipeline, data objects, algorithms, worked examples, and state machines, expressed as method operations and stored computer instructions.

### Node Class Field Requirements

Base node may include at least base_scope, applicant_bedid, root policy, proof root, ATMS optional route, resolver route, and default BEIFR2 boundary.

Territory node may include at least territory_scope, geographic or digital region descriptor, operator BEDID, public-service flag, governance authority, sub-node creation permission, and territory overlap policy.

RFP operator node may include at least RFP identifier, applicant score, selection authority, award proof, operator BEDID, limited operating scope, license term, and remediation trigger for nonperformance or scope breach.

Franchise node may include at least franchisor BEDID, franchisee BEDID, franchise scope, territory, service class, royalty basis, quality control field, termination condition, and child retail permission.

Chain node may include at least parent chain identifier, brand or system policy, branch set, shared ATMS route, shared standards profile, chain-wide remediation rule, and branch-level proof chain references.

Retail node may include at least store doorplate, parent_node, retail location or service area, terminal endpoints, customer-service endpoint, inventory or service category, payment route, and privacy disclosure rule.

Market node may include at least listing identifier, license field, transfer condition, data-room pointer, royalty basis, marketplace route, proof artifact set, and market-listing conflict status.

Medical node may include at least provider license digest, medical service class, privacy tier, scope-token profile, regulator access route, health-grain record route, insurance or grant route, and privacy-safe remediation rule.

ATMS node may include at least account graph route, clearing matrix, currency or unit class, nonce gate status, settlement proof root, compliance profile, and rail-adapter pointer.

Index node may include at least index route, computation profile, BEIGDP or BEIIndex algorithm identifier, component score fields, confidence interval, prior index pointer, and publication policy.

Governance node may include at least authority scope, voting threshold, standards version, policy update rule, revocation path, appeal route, and governance transition receipt.

Resolver node may include at least BEIDNS route, scope token policy, resolution receipt rule, denial receipt rule, TTL, revocation reference, and verifier reconstruction route.

Data-room node may include at least claim-to-SKU pointer, patent-family pointer, domain asset pointer, proof bundle, valuation framework tag, license field, audit anchor, and access policy.

Sector node may include at least NeedPack or IndustryPack identifier, sector class, standards profile, authorized templates, field-of-use policy, data schema, and sector-specific remediation trigger.

### DRAWING REFERENCE NUMERAL SUPPORT

FIG. 1 supports overall BEITLD registration architecture with reference numerals for RegistrationIntentEnvelope, Canonicalizer, NonDup Gate, Root Record Memory, PolicyContainer, BEI Operating Node, Proof Pipeline, and ATMS/Market/Index/BEIFR2 routes.

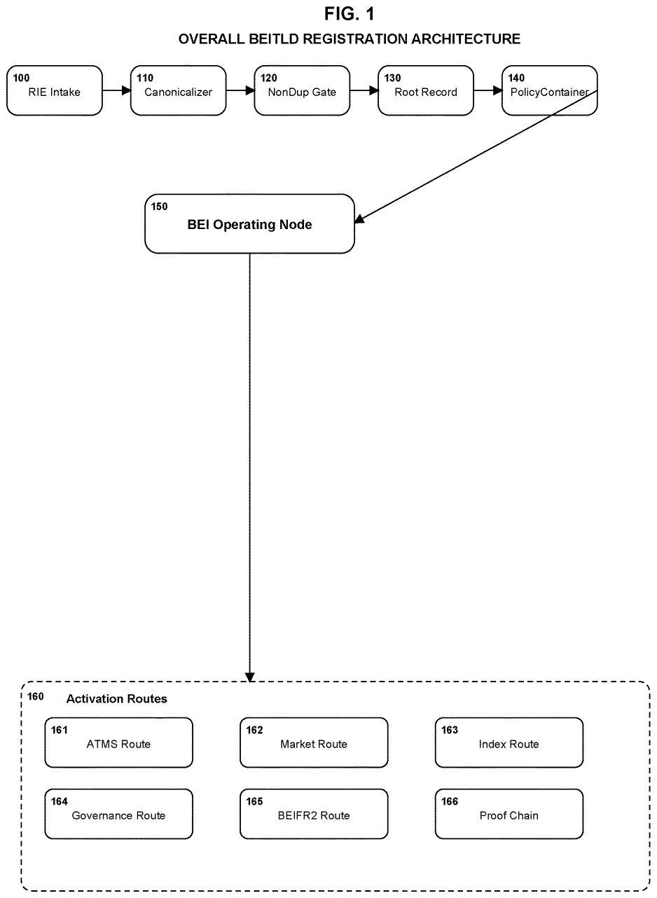

FIG. 2 supports technical transformation/ordered combination diagram showing a conventional passive registrar record and the BEITLD special-purpose registry machine outputting an active proof-carrying node with bounded remediation.

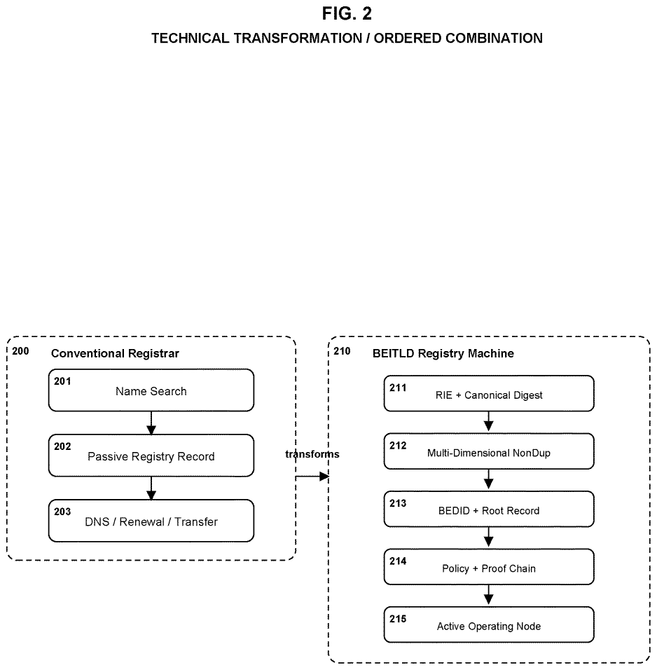

FIG. 3 supports RegistrationIntentEnvelope data structure including envelope identifier, applicant BEDID, identity anchor, scope coordinates, evidence digest, policy template, signature set, and nonce.

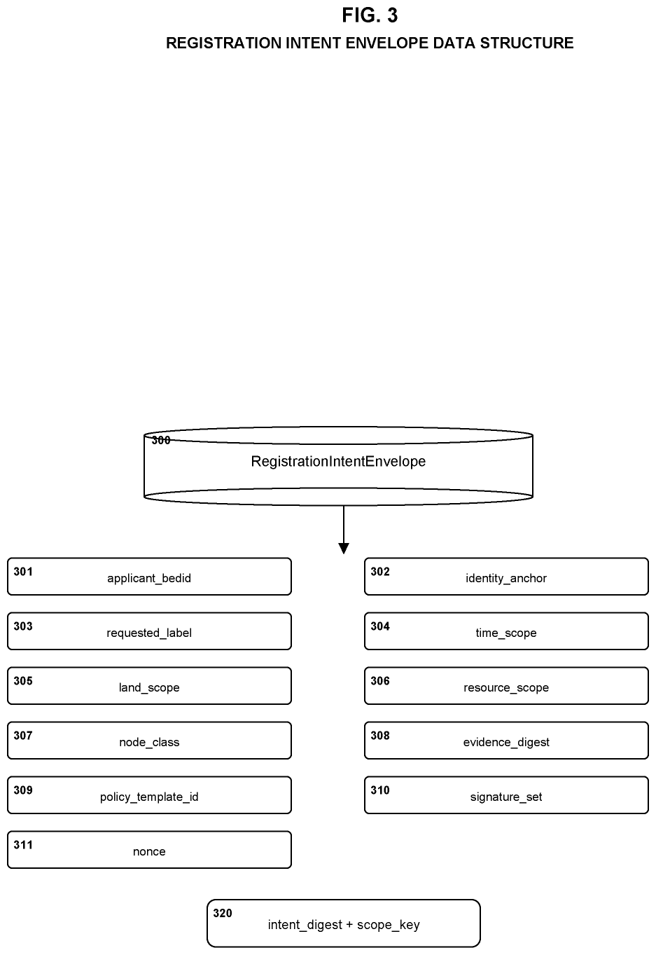

FIG. 4 supports BEI Doorplate and identity binding including applicant identity, behavioral extractor, feature vector, identity anchor hash, doorplate/BEDID, and binding receipt.

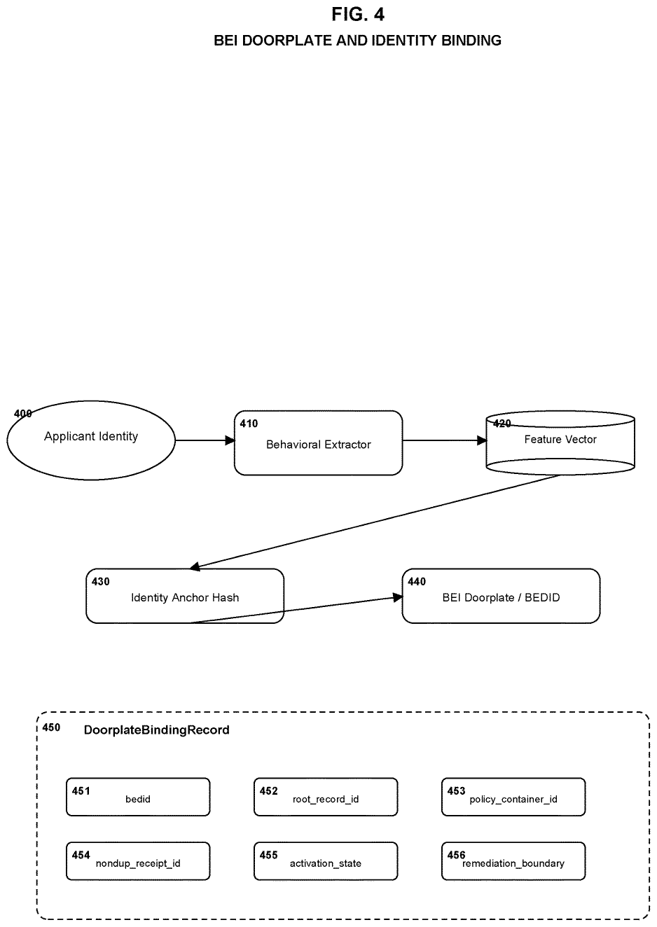

FIG. 5 supports multidimensional NonDup controller with separate indexes for label, identity, time, land/resource, territory, franchise, retail, market, and policy dimensions and an output NonDuplicationReceipt or reason code.

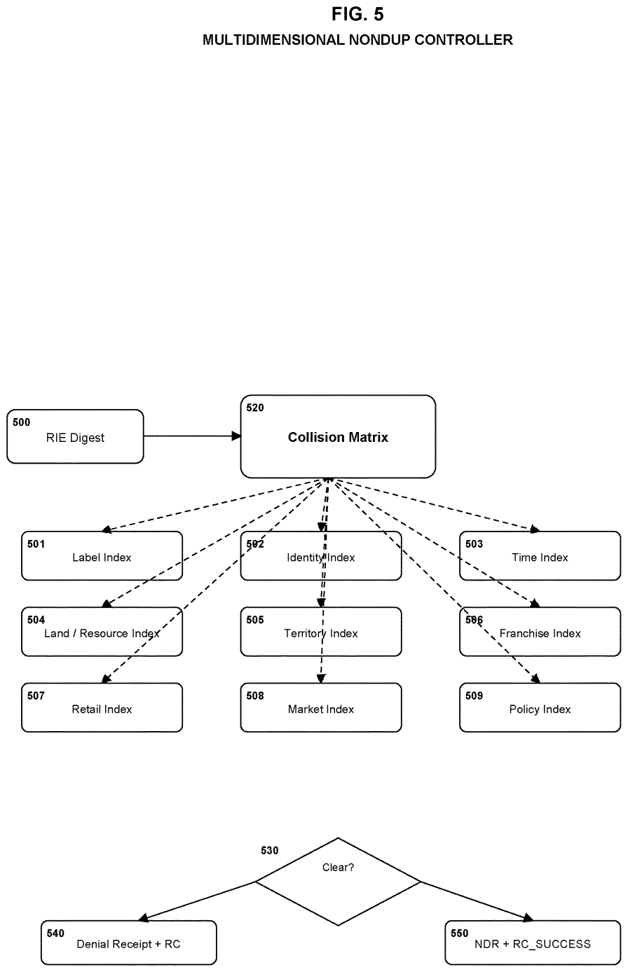

FIG. 6 supports PolicyContainer injection into the root record and downstream enforcement of eligibility, disclosure, settlement, governance, standards, and BEIFR2 boundaries.

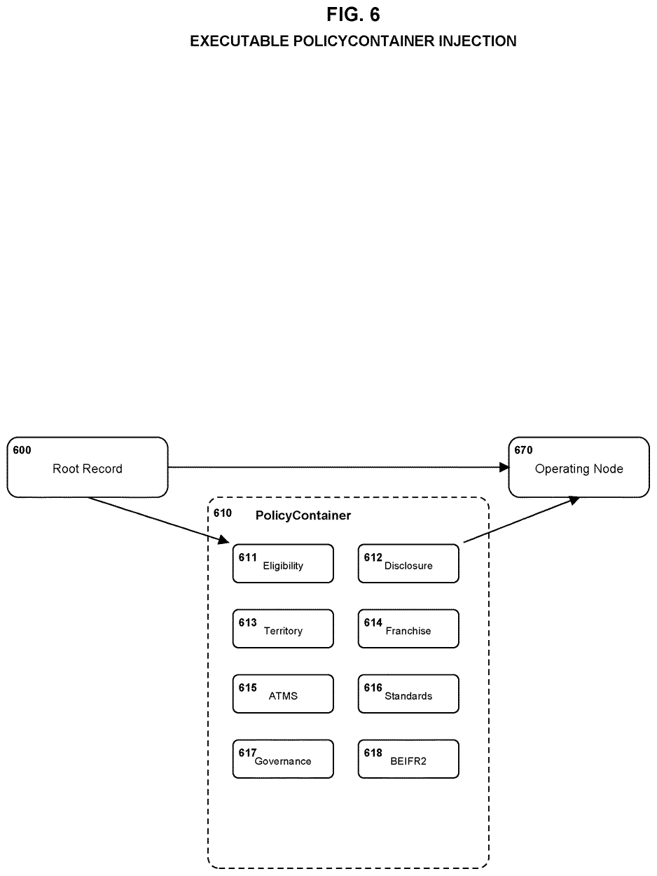

FIG. 7 supports Operating Node lifecycle state machine with reserved, queued, nondup checked, policy bound, root created, proof generated, active, suspended, remediated, and archived states.

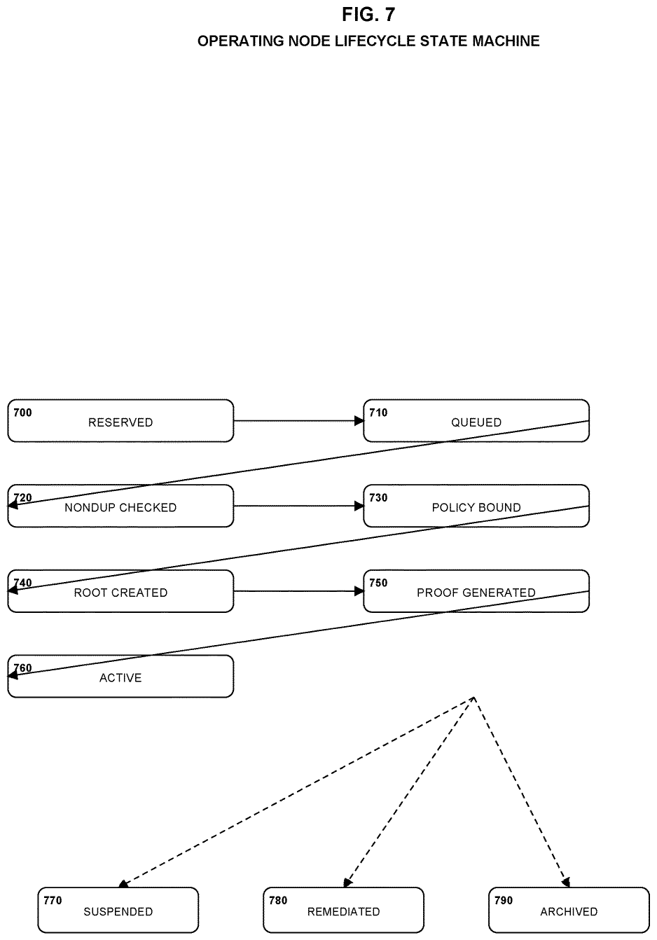

FIG. 8 supports proof artifact pipeline and FinalityMarker with RIE, DoorplateBindingRecord, RootRecord, PolicyContainer, NDR, RRec, ACR, FinalityMarker, and verifier reconstruction.

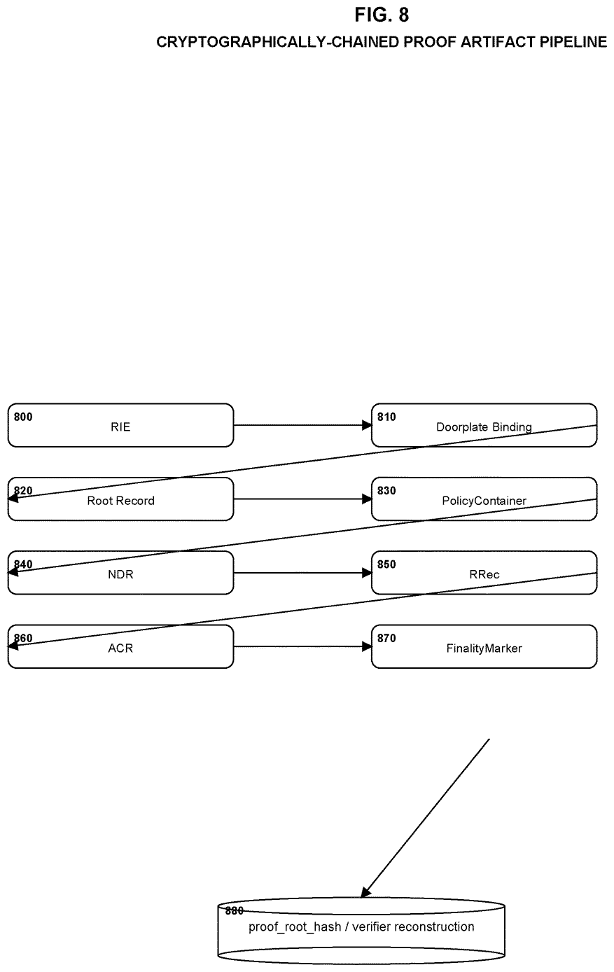

FIG. 9 supports ATMS deterministic clearing integration with namespace address, account graph, canonical transaction hash, nonce gate, settlement matrix, ATMS receipt, and Finality pointer.

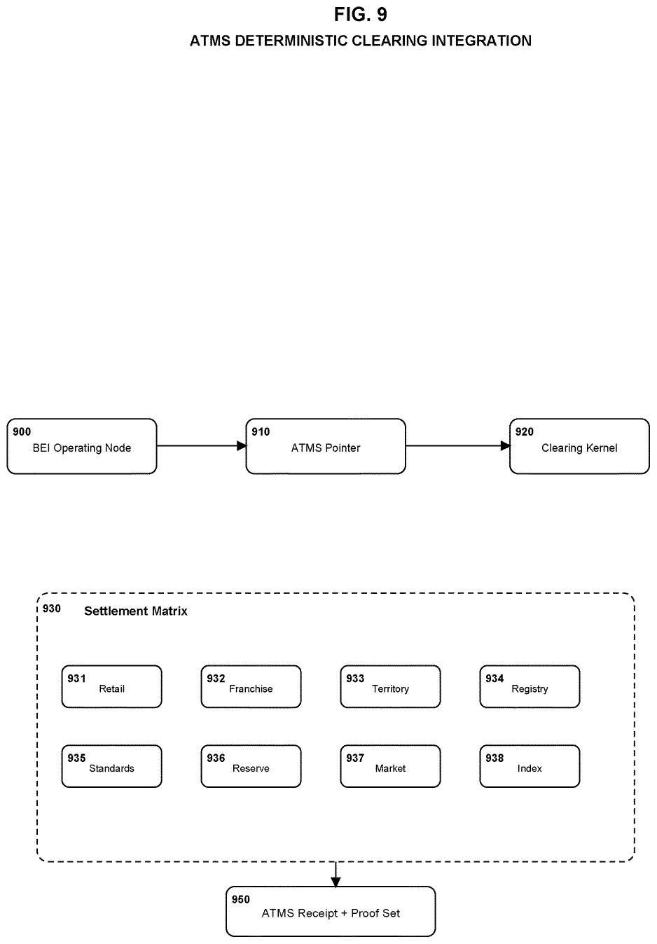

FIG. 10 supports BEIDNS resolution-as-evidence lookup including resolver gateway, scope token, policy execution, result or denial, Resolution Receipt, and audit anchor.

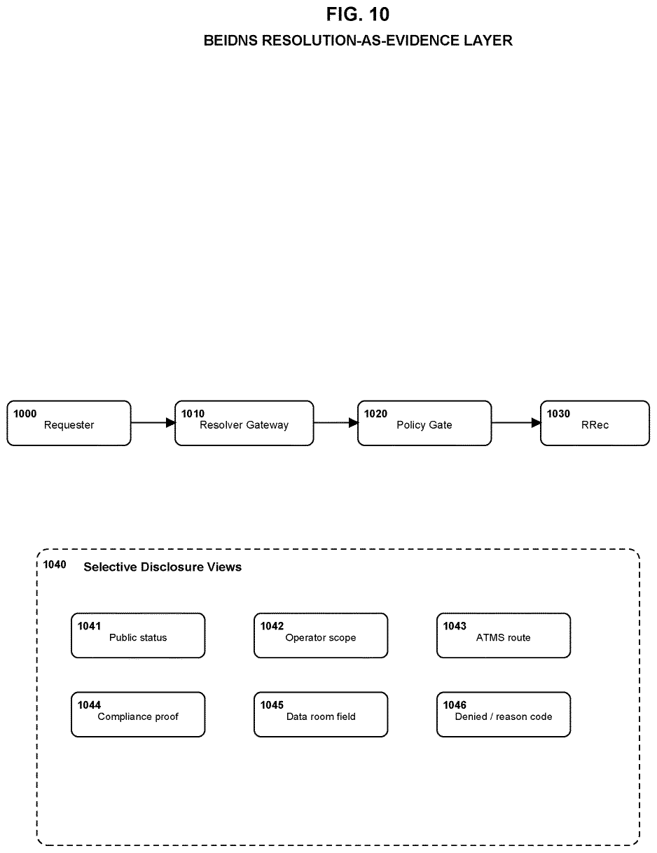

FIG. 11 supports BEIRFP to operator assignment flow including RFP intake, applicant score, operator BEDID, territory scope, policy route, operator root record, and authority marker.

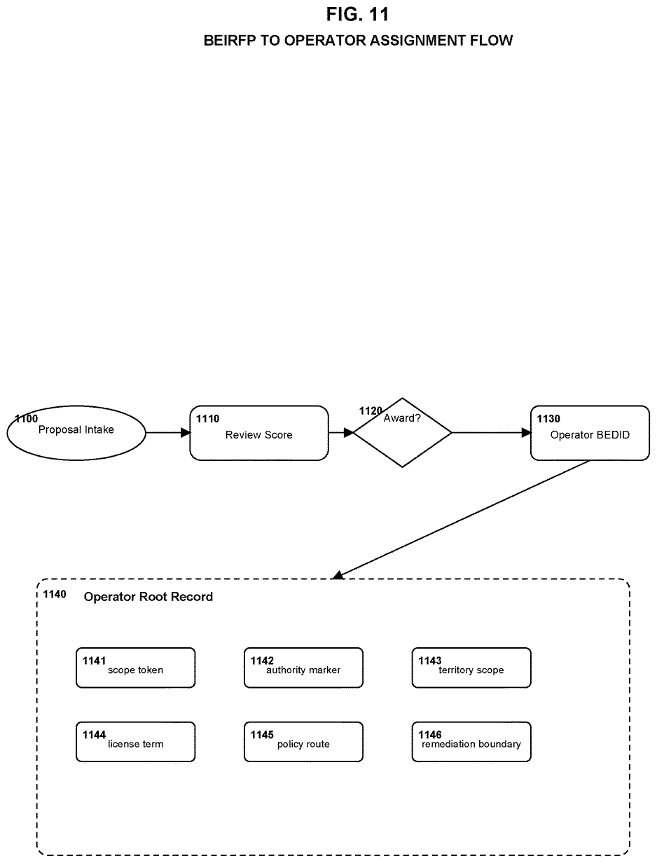

FIG. 12 supports territory, franchise, chain, and retail node topology with parent-child relationships, service nodes, market node, and separate proof chains.

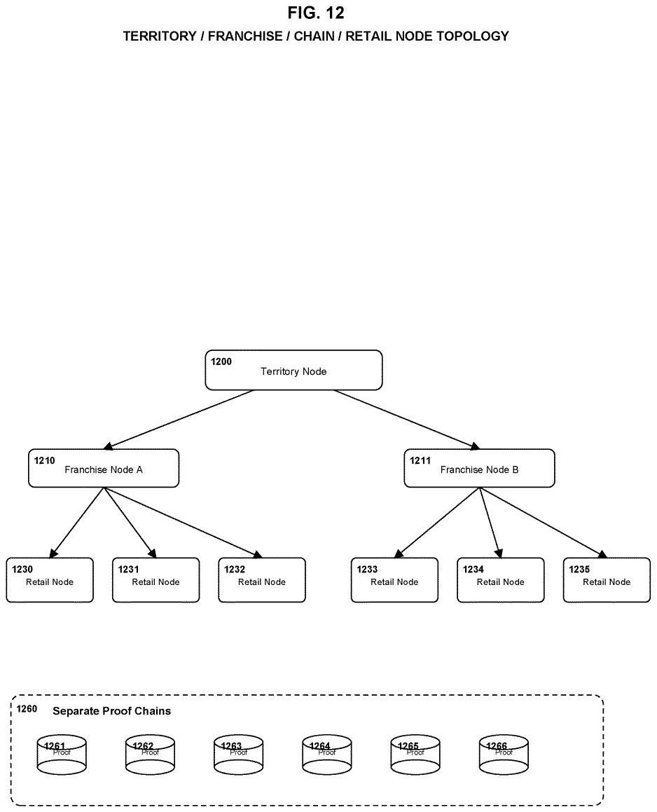

FIG. 13 supports market listing and data-room output showing operating node, license field, proof artifact set, domain asset pointer, patent-family pointer, royalty basis, and data-room record.

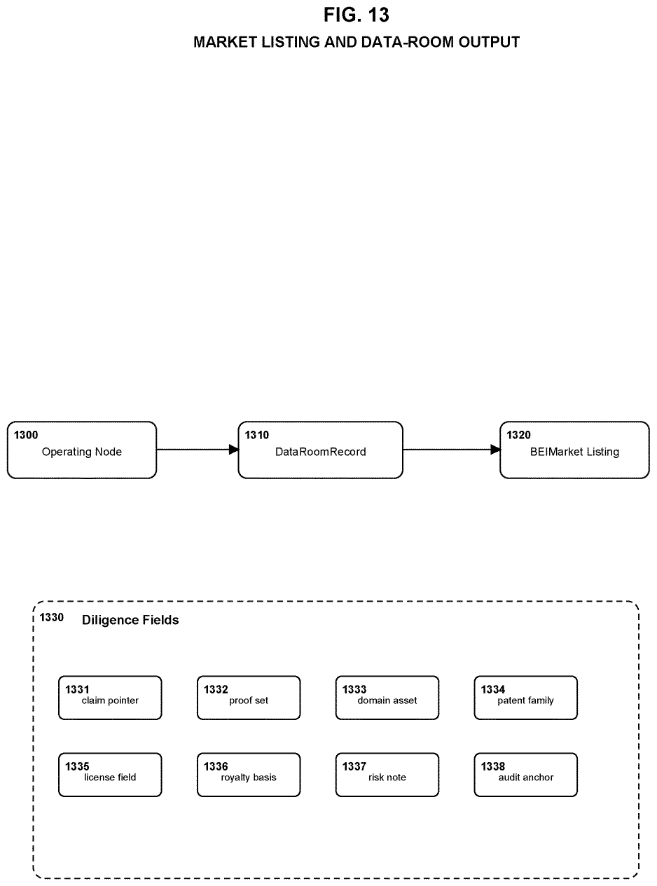

FIG. 14 supports BEIFR2 bounded remediation state machine showing nominal state, remediation request, dependency graph, affected node set, bounded rollback, final remediation, and unaffected nodes continuing.

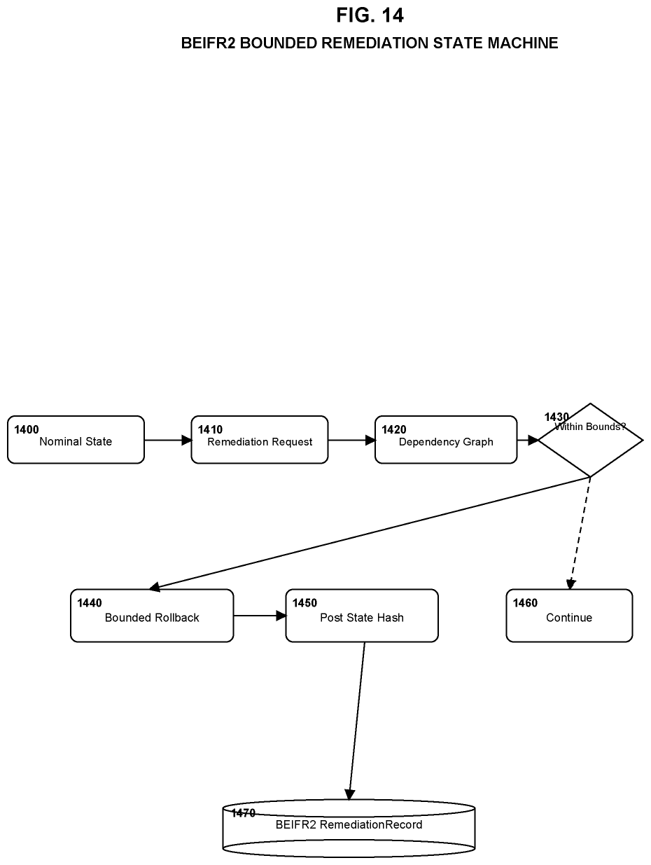

FIG. 15 supports BEIFR2 blast-radius dependency graph with trigger node, child nodes, ATMS routes, market listings, affected fence, unaffected siblings, and remediation record.

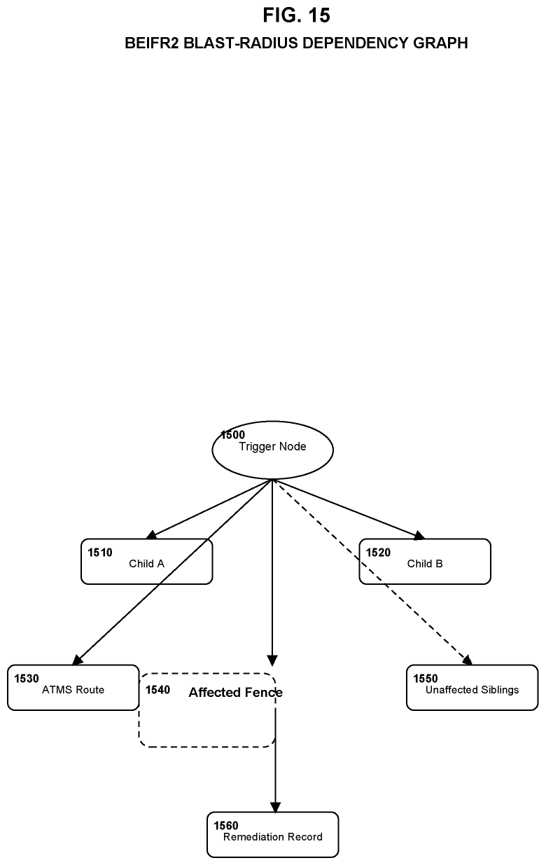

FIG. 16 supports BIRSTDSEC standards and governance binding with standards profile, field schema, algorithm identifiers, signature rules, audit retention, dispute route, and governance transition.

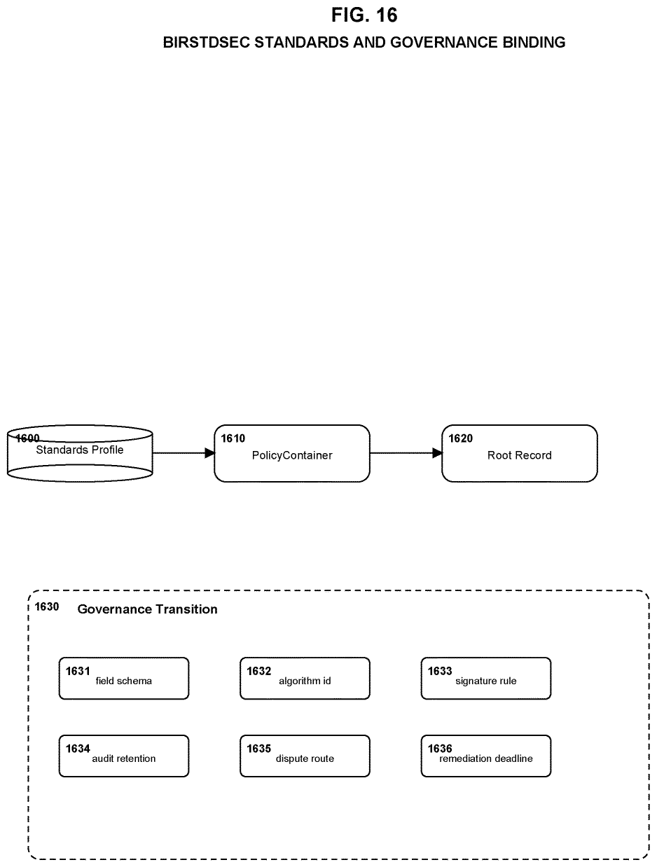

FIG. 17 supports BEIChip/TimeChip trusted execution inputs including BEIChip or TEE, TimeChip, signed asset state, attestation, RIE generation, and trusted input gate.

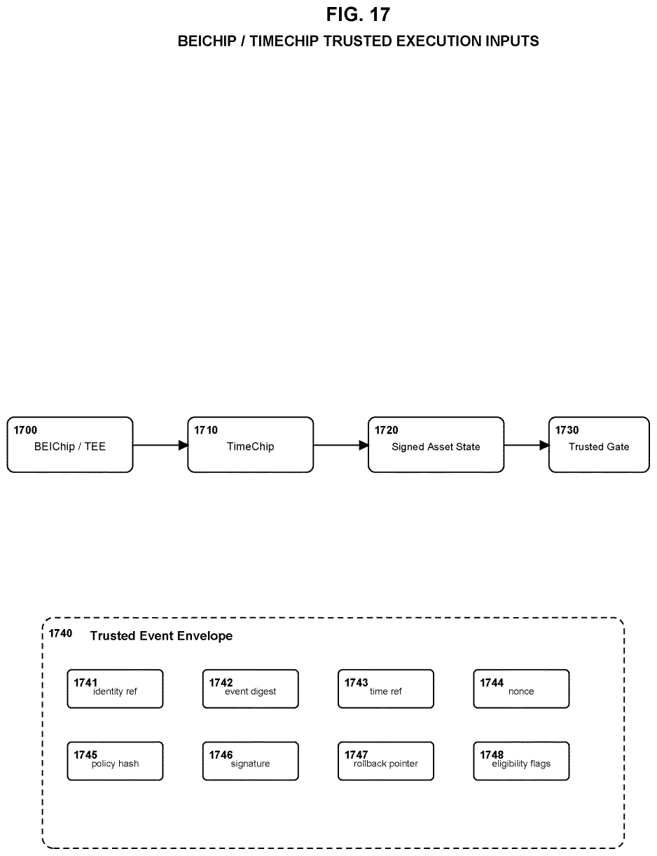

FIG. 18 supports BEI-TOT/BEI-SOS fission execution layer including active node, service event, fission root, derivative graph, currency/index/license route, and asset package output.

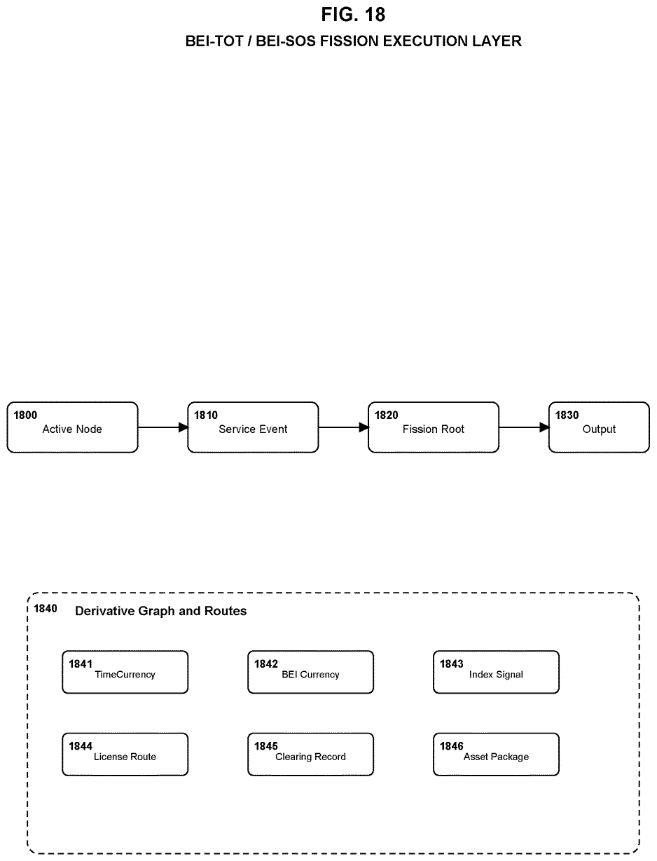

FIG. 19 supports NeedPack/IndustryPack multi-sector deployment including medical, finance, education, IoT, retail, and policy routes.

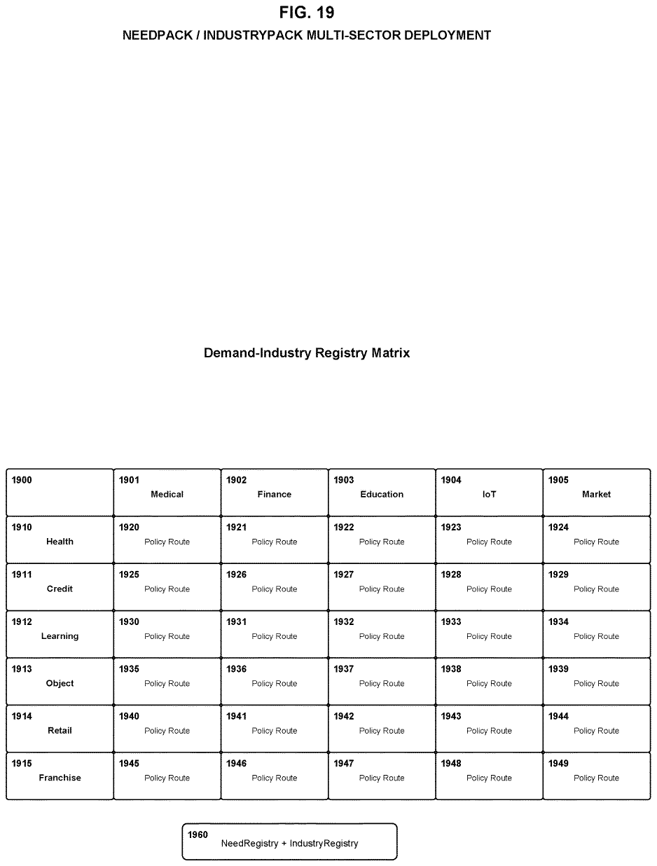

FIG. 20 supports claim-to-SKU and data-room mapping including claim element, patent family pointer, domain asset pointer, SKU module, license field, royalty basis, and data-room evidence.

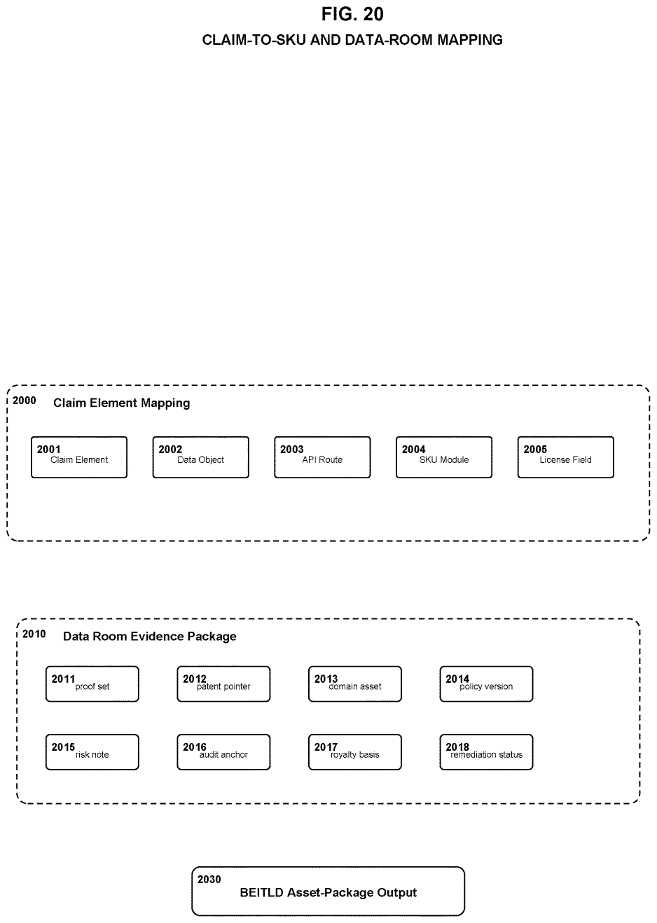

### TECHNICAL DISTINCTIONS OVER REPRESENTATIVE PRIOR ART

Conventional DNS and ICANN registrar systems: produce a passive name record, DNS zone entry, registrant record, or lifecycle status. They do not generate a BEI Operating Node with a PolicyContainer, proof artifact chain, ATMS activation pointer, FinalityMarker, and BEIFR2 boundary at the moment of registration.

WHOIS, RDAP, and registrar availability services: perform name lookup, registrant lookup, status return, or policy display. They do not perform a multidimensional NonDup collision matrix across label, identity, time, land/resource, territory, franchise, retail, market, and policy dimensions.

W3C DID and verifiable credential systems: provide identity identifiers, DID documents, verification methods, or credential presentations. They do not create Time-Land-Resource root records, ATMS clearing routes, market listing routes, BEIGDP or BEIIndex routes, or bounded-remediation dependency graphs at registration origin.

ENS and blockchain naming services: associate a tokenized name with an owner or resolver. They do not provide behavioral identity extraction, nine-dimensional NonDup checking, executable PolicyContainer injection, FinalityMarker-based multi-route activation, or BEIFR2 blast-radius remediation.

Conventional payment and settlement rails: process payments or settlement messages but do not initiate from a BEITLD root record or produce a FinalityMarker that simultaneously activates identity, market, governance, index, and remediation routes.

Marketplace and franchise management systems: may list assets or manage franchise agreements but do not create a root registry object that binds a BEDID, Time-Land-Resource scope, PolicyContainer, proof chain, ATMS route, market listing, and BEIFR2 boundary.

Immutable blockchain ledgers: provide append-only state but generally do not provide bounded remediation with affected_node_set and unaffected_node_set proof. BEIFR2 improves computer reliability by limiting correction to the computed dependency graph while preserving unaffected node continuity.

Company formation and registered agent services: create legal entity records or registered-agent appointments but do not generate a machine-verifiable Time-Land-Resource Operating Node with proof pipeline, NonDup receipt, PolicyContainer, and downstream ATMS/market/index routes.

Generic workflow engines: may coordinate tasks but lack the specific data structures, proof artifacts, multidimensional scope indexes, FinalityMarker, and bounded-remediation state machine disclosed here.

Generic AI identity or fraud systems: may compute risk scores but do not allocate a BEDID and activate a registry root record through a proof-carrying registration-origin pipeline.

### Asset Package and License-Field Implementation Support

NonDup Gate license field: may be licensed to domain registries, identity services, financial fraud systems, government registries, IoT registries, and enterprise data-room platforms as a multidimensional collision-detection API.

Proof Artifact Pipeline license field: may be licensed to compliance systems, audit systems, legal technology systems, healthcare evidence systems, and government registries requiring verifier reconstruction.

PolicyContainer license field: may be licensed to enterprise registries, franchise operators, market operators, standards bodies, and governance systems requiring versioned machine-interpretable rules.

BEITLD Root Record and Node Activation license field: may be licensed to registry operators, healthcare systems, real-estate systems, public-service systems, and enterprise infrastructure operators as the base node activation layer.

ATMS Clearing Integration license field: may be licensed to fintech platforms, payment processors, clearinghouses, and banking-sidecar systems as a deterministic settlement and proof-set interface.

Franchise, Chain, and Retail Node license field: may be licensed to retail chains, hospitality networks, service networks, supply chains, education networks, and public-service operators for node-level registration and proof-chain management.

BEIFR2 remediation license field: may be licensed to legal technology, dispute resolution, compliance, financial systems, government registries, and healthcare systems requiring bounded correction without system-wide invalidation.

BIRSTDSEC standards license field: may be licensed to standards bodies, regulated industries, healthcare systems, finance systems, and public infrastructure operators for field schemas, reason codes, audit retention, and remediation rules.

BEIRFP operator selection license field: may be licensed to government, NGO, regional, industry, and enterprise RFP systems that convert awards into registry operator nodes.

Data Room and Market Listing license field: may be licensed to IP transaction platforms, M&A platforms, SPAC due diligence systems, private equity platforms, and domain portfolio operators as claim-to-SKU evidence mapping.

### Additional Worked Examples and Safety Boundaries

Founder domain continuity record: A founder-domain continuity record may include historical domain registration events, renewal events, abandonment events, reacquisition events, reconfiguration events, portfolio classification events, domain asset pointers, patent-family pointers, licensing status fields, and evidence pointers. The record may support data-room evaluation without constituting proof of market value by itself.

Company formation and territory registry adapter: An external infrastructure adapter may receive a business formation record, registered agent record, corporate status record, domain-registration record, industry-operator record, or regional-operator credential and bind it to a BEITLD root record through a scope token, PolicyContainer rule, and proof artifact.

Domain territory allocation: A territory allocation rule may assign limited operating scope to an operator BEDID for a domain cluster, industry field, geographic region, franchise scope, or ecosystem package. The system generates a TerritoryOperationsRecord with license term, royalty basis, termination condition, governance rule, and remediation boundary.

AI agent trusted route: An AI-agent node may register a model, service route, authority scope, data policy, identity anchor, governance rule, and remediation boundary. The node may be denied if the PolicyContainer identifies unsafe scope, expired authority, or conflicting market listing.

Public-service registration: A public-service registry may convert healthcare, emergency, education, water, safety, or aid endpoints into public-interest nodes. The PolicyContainer may prioritize access and disclosure while preserving Resolution Receipts and audit anchors.

Cross-border interoperability: A regional operator may bind local legal records, industry records, bank rails, or public registries to a BEITLD root record using external adapters. The BEITLD root record remains the technical registry node, while external legal effect remains subject to the external system.

No investment guarantee: ATMS, BEIGDP, BEIIndex, market listings, and data-room outputs are technical records computed from machine-readable registry states. They are not promises of income, securities, profit, market value, or legal title unless separately established under applicable law.

Privacy protection: Sensitive identity, medical, financial, location, behavioral, or franchise fields may be hidden from public records and disclosed only through scope-token access, privacy filters, zero-knowledge proofs, or authorized data-room access.

Independent node remediation: A child retail node can be remediated without invalidating unrelated sibling nodes or parent nodes when the dependency graph proves that the blast radius is limited to the child node and directly dependent artifacts.

Registrar-grade user interface: A user may experience a conventional registrar-like interface, but every material step maps to a back-end data object, proof artifact, reason code, state transition, or remediation boundary. The invention resides in the machine transformation and not the visual interface.

### Technical Effects of the Disclosed System

### Core Technical Contribution for Examination and Data Room Use

The technical problem addressed by the disclosed system is that conventional domain registration creates passive naming records while identity, policy governance, proof, clearing, market listing, index routing, and remediation remain fragmented across separate systems.

The technical solution is a special-purpose BEITLD registry machine that converts a BEI Time-Land-Resource registration intent into an active, proof-carrying, policy-governed BEI Operating Node at the moment of registration. The machine receives a RegistrationIntentEnvelope, canonicalizes the requested scope, executes multidimensional NonDup/NonConflict/NonOverlap evaluation, creates a BEITLD root record, injects a PolicyContainer, generates proof artifacts, issues a FinalityMarker, and exposes activation pointers for ATMS, market, index, governance, and BEIFR2 bounded remediation.

The inventive ordered combination is not a conventional registrar workflow plus a business rule. Each stage produces a machine-readable artifact used by the next stage: intent digest, nonduplication scope key, NonDuplicationReceipt, root record, PolicyContainer binding, proof_root_hash, FinalityMarker, route pointers, and remediation boundary.

The practical technical improvement is improved registry operation through deterministic canonicalization, multidimensional conflict detection, proof-carrying state transitions, field-level selective disclosure, verifier reconstruction, atomic clearing synchronization, and bounded dependency-graph remediation.

The disclosed system improves registry computing by replacing a single-string availability check with a multidimensional collision matrix and pending-lock mechanism that reduces race conditions and inconsistent allocation across identity, time, land/resource, territory, franchise, retail, market, and policy dimensions.

The disclosed system improves proof and audit computing by chaining registration artifacts from intent through FinalityMarker, allowing a verifier to reconstruct the registry decision using the canonical intent digest, policy version, proof root, audit anchor, and state-transition log.

The disclosed system improves remediation computing by computing a dependency graph and blast radius before rollback, freezing only affected routes, preserving unaffected sibling and parent nodes, and issuing post-remediation FinalityMarkers for bounded correction.

The disclosed system improves interoperation by using a structured FinalityMarker with pointers to ATMS, BEIMarket, BEIGDP or BEIIndex, governance, and BEIFR2 routes rather than merely exposing functional endpoints.

The disclosed system improves written-description support for computer implementation by defining data objects, field tables, reason codes, algorithms, state machines, and representative node examples sufficient for a person of ordinary skill to implement the registry system using conventional processors, memory, databases, cryptographic libraries, HSMs, TEEs, APIs, or distributed registry infrastructure.

The disclosed system preserves the registration-origin main chain. Related BEI infrastructure layers may provide trusted execution, clearing, fission, index, marketplace, and remediation services, but the BEITLD invention remains focused on how a registration event creates a BEDID-bound Time-Land-Resource Operating Node.

### Final Supplemental Continuity, Application, and Enablement Support

### ADS Cross-Reference and Technical Family Spine

This disclosed supplemental section preserves the registration-origin subject matter described above and further coordinates related BEI, ATMS, DomainPI, BEIDNS, BEIFR2, BEIChip, BEIMINT, TimeCurrency, BEI Currency, BEIGX, BEIIndex, 24HWS, and sector-node disclosures as technical background, implementation support, and data-room mapping. Any domestic benefit, continuation-in-part, divisional, or priority relationship remains controlled by the formal Application Data Sheet and accepted USPTO filing record.

The family spine is not used to turn the present disclosure into a loose aggregation. The present invention remains focused on the special-purpose BEITLD registry machine that transforms a registration intent into an active, proof-carrying, policy-governed BEI Operating Node. Related applications provide input layers, execution layers, clearing layers, security layers, sector embodiments, product paths, and asset-package evidence for that registration-origin passage.

A core ADS candidate group may include domain and namespace cases, identity-anchor cases, deterministic kernel cases, ATMS and clearing cases, BEIFR2 correction cases, BEIChip or trusted execution cases, BEIMINT and TimeCurrency cases, SCEOS or BEISOS cases, and sector implementation cases, provided that each is verified for filing date, continuity, copendency, relationship type, and written-description relevance before it is relied upon in the official ADS.

Applications not listed in the formal ADS may still be used as related, companion, branch, background, implementation, product, or asset-package context. Such context may show how the BEITLD node connects to identity, routing, minting, clearing, market listing, standards certification, and industry deployment without expanding the legal priority claim beyond the official filing record.

The technical family may be organized as a patent-family matrix, standards-protocol stack, industry asset package, product package, and evidence package. This organization converts a portfolio list into a machine-readable licensing and due-diligence structure: claim element, data object, API route, node class, domain asset, standards profile, use case, industry field, proof artifact, and monetization field.

The preferred disclosure hierarchy is: BEITLD registration layer; BEI identity and doorplate layer; BEIDNS resolution-as-evidence layer; PolicyContainer and standards layer; NonDup/NonConflict/NonOverlap gate; BEI Operating Node activation layer; ATMS clearing layer; BEIMINT and TimeCurrency layer; BEIIndex/BEIGDP layer; BEIRFP, territory, franchise, chain, retail, and market layer; BEIFR2 correction layer; and Data Room/asset-package layer.

The registration layer is the legal and technical choke point. A domain, subdomain, Time-Land-Resource label, territory parcel, industry node, family node, retail node, public-service node, medical node, or AI-agent route becomes usable only after the registry machine assigns or binds a BEDID or BEI Doorplate, creates the root record, injects the PolicyContainer, issues proof artifacts, and establishes the remediation boundary.

The ADS coordination record may include a ParentSupportTag, a RelatedSupportTag, an ImplementationSupportTag, and a DataRoomSupportTag. These tags are not substitutes for legal priority, but they help a prosecutor, examiner, investor, licensee, or technical diligence reviewer understand which earlier application supports which present claim element or implementation route.

The present application therefore uses the uploaded ADS coordination materials as a guide for organizing related support while maintaining a single theme: a registrar-like user experience backed by a non-registrar technical transformation into an active BEI Time-Land-Resource Operating Node.

This treatment avoids a change of style or subject. The document does not become a portfolio catalog. It remains a registration operating system disclosure, with the portfolio and ADS cross-reference material acting as support, evidence, and implementation examples for the same registration spine.

### Additional Definitions, Standard Profiles, and Protocol Objects

BEITMD, BEITLD, or BEI Time-Land-Resource Domain may refer to a domain-like registry object that binds a time dimension, land or digital land dimension, resource dimension, identity anchor, policy container, proof chain, and operating-node class. The term may be used as a technical registry category rather than as a conventional ICANN top-level domain.

Time-Land-Resource scope may include one or more of a time coordinate, life-time coordinate, domain label, subdomain label, digital land parcel, physical territory, industry field, service field, resource object, water, light, electricity, air, solar-origin signal, medical node, retail terminal, AI-agent route, or governance route.

BEI Doorplate means a machine-resolvable address or doorplate number assigned to a person, family, organization, device, territory, franchise, chain, retail store, medical node, public-service node, or market node, where the doorplate is linked to a BEDID, root record, policy, proof chain, and lifecycle state.

BIRSTDSEC means a BEI standards, practice, and security profile that can specify field requirements, signature algorithms, policy-container versions, reason codes, audit-retention periods, node-class requirements, disclosure rules, remediation windows, and certification tests for a BEITLD implementation.

A Practice Rule or Law-Like Standard Profile may be implemented as a versioned PolicyContainer and not merely as a human-readable policy statement. The profile can be signed, stored, referenced by root records, and replayed by a verifier during audit, dispute, renewal, transfer, or remediation.

An IndustryPack means a reusable policy, proof, node, and settlement package for a sector such as healthcare, banking, education, retail, government, energy, IoT, telecommunications, real estate, insurance, supply chain, public service, agriculture, media, transportation, or standards certification.

A NeedPack means a reusable configuration for a human or institutional need, including health, credit, learning, care, employment, public service, safety, housing, food, water, energy, mobility, identity, education, finance, family support, environmental contribution, invention, or governance.

The phrase 999 needs and 365 industries is implemented as a registry matrix rather than as unsupported breadth. Each need or industry preferably has a need_id or industry_id, data schema, authorized proof sources, PolicyContainer version, eligible node classes, clearing route, index weight, standards profile, and remediation rule.

All currencies support means the registry may store currency route records for fiat, stablecoin, CBDC, BEI Currency, TimeCurrency, service unit, voucher, internal accounting unit, exchange unit, reserve unit, index unit, or non-currency proof unit. The system does not require any output unit to be legal tender.

All resources support means the registry may accept resource_scope records for tangible or intangible resources, including land, digital land, domain resources, water, light, electricity, air, solar-origin signals, medical services, education services, retail services, public-service capacity, patent resources, data-room assets, and standards resources.

### 999 Needs/365 Industry Application Matrix Under the Registration Spine

The BEITLD registry may operate a NeedRegistry that stores need_id, need_category, required_identity_level, acceptable proof sources, behavior object schema, time-window rule, PolicyContainer pointer, output eligibility, ATMS route, index weight, privacy level, and remediation rule.

The BEITLD registry may operate an IndustryRegistry that stores industry_id, jurisdiction profile, authorized operator classes, licensing requirements, standards profile, node templates, proof source rules, settlement profile, data-room profile, and risk or correction policy.

For healthcare, the system may receive a medical-node registration intent, bind a provider or institution BEDID, check territory, license, privacy, and patient-object rules, create a medical operating node, and expose proof, privacy, insurance, grant, health-index, and BEIFR2 routes.

For education, the system may register a school, teacher, credential issuer, tutoring node, course node, or learning terminal, bind the node to proof sources and credential schemas, and route learning-time receipts to education TimeCurrency, skill index, scholarship, or employer-verification routes.

For banking and fintech, the system may register a financial operator node, payment node, clearing node, credit node, or reserve node and bind it to ATMS, deterministic clearing, compliance profile, prudential rule, proof-set interface, and remediation boundary.

For retail, the system may register a store node, franchise node, point-of-sale terminal, merchant route, or market listing, bind it to a parent node and royalty basis, and activate customer receipt, inventory, settlement, loyalty, proof, and remediation routes.

For energy, water, green, and climate programs, the system may register resource nodes for water conservation, air quality, electricity saving, solar generation, environmental education, or public-resource stewardship and map resource receipts to green indices or reserve profiles.

For government and public service, the system may register public-interest nodes, emergency nodes, aid nodes, city nodes, public-health nodes, education nodes, and social-service nodes while using scope-token disclosure, standards profiles, audit routes, and public-service remediation logic.

For real estate and physical territory, the system may register territory parcels, building nodes, store nodes, lease nodes, mortgage-related proof nodes, utility nodes, IoT sensor nodes, and settlement routes while distinguishing technical registry state from external legal title.

For telecommunications and terminal systems, the system may register SIM/eSIM nodes, mobile terminals, telecom payment routes, device-mesh nodes, edge terminals, and offline receipt caches, each with device identity, endpoint signature, and synchronization state.

For AI agents and machine services, the system may register agent route nodes, model service nodes, proof-review nodes, anomaly-detection nodes, and AI-assisted valuation nodes, each having authority scope, data policy, safety rule, audit trace, and remediation boundary.

For intellectual property and invention, the system may register inventor nodes, patent-wall nodes, claim-to-SKU nodes, standard submission nodes, licensing nodes, and data-room nodes. Each such node may reference filing receipts, patent-family pointers, claim charts, proof records, and transfer status.

For family, personal, and household uses, the system may register a family doorplate, household resource node, care node, time bank node, education node, health node, or privacy-protected wallet node with separate disclosure and remediation policies.

For international and regional deployment, the system may register country, region, city, province, industry-zone, cross-border, NGO, development-bank, or sovereign operator nodes.

Each node may be limited by territory scope, external records, BIRSTDSEC profile, and local compliance adapters.

The matrix does not require the specification to enumerate all 999 needs or all 365 industries. It provides a repeatable machine pattern by which any need or industry can be represented as a node class, data schema, proof rule, PolicyContainer, clearing route, index route, and remediation boundary.

The technical benefit is that use-case breadth is not merely narrative breadth. Breadth is reduced to registry tables, node-class templates, policy versions, proof source types, scope keys, conflict matrices, route pointers, and finality artifacts that a computing system can store, execute, and verify.

### Product, Provisioning, Dashboard, and MVP Implementation Paths

A first product implementation may expose IdentityOS, RoutingOS, and MintOS as three mother products. IdentityOS registers the user, family, merchant, institution, or operator as a BEI identity anchor. RoutingOS binds the identity to a node or domain route. MintOS converts permitted time, behavior, or proof events into receipt-backed units or index-ready records.

The first product loop may be Identity, Routing, Mint, Asset, and Clearing. In a minimum viable implementation, the system may initially operate only Identity, Routing, and Mint while reserving ATMS clearing, exchange, and index routes for later activation after the FinalityMarker has been issued.

A homepage or product dashboard may present identity start products, land or terminal products, time and behavior minting products, and clearing or compliance products. Each product card may map to a node class, product SKU, claim element, PolicyContainer, proof route, and fulfillment state rather than being a mere marketing label.

A user dashboard may include Identity, Wallet, Terminal, Mint Panel, Exchange, Index, and Settings panels. The dashboard is optional user interface; the underlying invention remains the registry machine that records BEDID binding, node activation, proof artifacts, ATMS routes, and remediation boundaries.

A provisioning implementation may use an order, slug, reservation, multisite creation, node metadata, log, retry, and activation chain. A user selecting a subdomain-like slug triggers validation, reservation, payment or order status, site or node creation, metadata writing, notification, and state logging.

The provisioning pipeline may include SlugValidator, ReservationService, OrderTriggerService, ProvisioningEngine, UserService, SiteService, NodeRegistryService, LogService, RetryService, and API Module. These components provide an implementation example for how a registrar-like user experience becomes a BEI node opening workflow.

A provisioning node record may store node_uid, site_id, order_id, product_id, owner_user_id, slug, root_domain, basepoint, node_type, plan_code, template_code, policy_version, receipt_route, identity_binding_status, provisioning_state, activation_status, retry_count, last_error_code, created_at, updated_at, and metadata JSON.

A reservation record may store slug, root_domain, reservation_key, order_id, product_id, user_id, email, status, created_at, expires_at, consumed_at, cancelled_at, and metadata. This record supports concurrency control and prevents duplicate allocation before final node activation.

A provisioning log may store node_id, order_id, site_id, user_id, event type, status, error_code, message, context JSON, and timestamp. Log events may include slug_checked, slug_reserved, order_trigger_received, user_created, site_created, node_registry_written, provisioning_completed, provisioning_failed, and provisioning_retried.

The provisioning state machine may include queued, running, success, failed, partial, and retrying. The activation state machine may include pending, active, provisioning_failed, partially_provisioned, suspended, and archived. These states may map to the BEITLD lifecycle states described above.

Implementation interfaces may include availability checking, registration intent creation, node activation, proof retrieval, policy lookup, ATMS synchronization, market listing, index publication, BEIFR2 correction, and data-room output. REST, AJAX, SDK, smart contract, or batch interfaces may be used.

A product SKU may therefore be more than a sales item. It may be a claim-to-SKU technical unit that maps a product entry to a node class, root record, policy template, proof chain, license field, service level, data-room evidence, and remediation boundary.

The system may avoid placing strategic, city-level, industry-level, clearing-level, or governance-level nodes into ordinary self-checkout. Such nodes may require quote-required, manual-review, RFP, or external infrastructure adapter processing, while still using the same registry data objects and proof artifacts.

This product path supports asset-package valuation by showing how the protected control passage can become a working interface, provisioning plugin, dashboard, product catalog, licensing field, and data-room record without turning the patent into a mere business plan.

### Founder Domain Continuity, Territory, and Operator Assignment

Founder domain continuity may be recorded as a time-continuity spine from earlier domain acquisition, renewal, abandonment, reacquisition, restructuring, portfolio classification, product mapping, and patent-family mapping events to the present BEITLD root records.

A FounderDomainContinuityRecord may include continuity record_id, domain_name, acquisition_date, renewal_events, lapse_events, reacquisition_events, portfolio_class, associated patent families, associated trademarks, use history, current node class, data-room evidence pointer, and signature or attestation source.

The continuity record does not by itself prove market value or legal scope. It provides evidence that a domain resource is part of a long-running technical and asset-package spine and may help a diligence reviewer connect domain assets, patent claims, product SKUs, and node activation records. In some embodiments, a technical operating endpoint, such as beioperating.com, may serve as a technical master gate for activation of BEI Operating Nodes, while an operations endpoint, such as beioperations.com, may serve as an operator-management master gate for lifecycle management, territory allocation, franchise or retail operation, licensing, market listing, data-room diligence, governance transition, and bounded remediation. Such endpoints may be stored as non-limiting domain-asset pointers, registry-interface endpoints, operator-console endpoints, or founder-domain-continuity records associated with a BEITLD root record. The disclosed BEITLD registration operating system protects the registration-origin pathway that connects digital territory, domain assets, BEI Operating Nodes, licensing networks, ATMS routes, market routes, index routes, and capital data-room evidence into a proof-carrying BEI Time-Land-Resource registry infrastructure.

Territory allocation may operate on domain clusters rather than isolated names. A domain cluster may include a root domain, subdomains, country or region nodes, industry nodes, branch nodes, franchise nodes, and retail nodes governed by a shared or inherited PolicyContainer.

An OperatorAssignmentRecord may include operator_bedid, domain_cluster_id, territory_scope, industry_scope, node_class, license_start, license_end, rights_bundle, royalty_basis, sublicensing permission, governance rule, reporting route, and remediation boundary.

Rights bundles may be separated into technical rights, commercial rights, data-room rights, proof-route rights, clearing-route rights, standards-certification rights, RFP rights, market-listing rights, and remediation rights. A bundle may be granted, denied, suspended, transferred, limited, or revoked through proof-carrying state transitions.

A wholesale territory or cluster grant may be implemented as limited operating scope, not as uncontrolled assignment of all rights. The registry can retain root control, standards rules, audit rights, correction rights, and finality rules while delegating local operation to a regional or industry operator.

Operator assignment may include anti-hoarding, performance, audit, service quality, claim-to-SKU usage, market listing, royalty reporting, local compliance, and public-service obligations. Failure can trigger freeze, scope reduction, successor assignment, or BEIFR2 remediation.

The territory layer allows the system to resemble a registrar, franchise system, regional operator network, and digital land registry while retaining a unified technical pathway: RIE, NonDup, root record, PolicyContainer, FinalityMarker, routes, and remediation boundary.

The technical difference from a mere franchise contract is that the operator assignment is stored as a machine-readable record with scope keys, proof roots, state transitions, route permissions, audit anchors, and bounded remediation triggers.

### Sovereign Domain Operations Controller

A Sovereign Domain Operations Controller may be implemented as a registry subsystem that orchestrates multiple routes after a BEITLD root record reaches active state. The controller does not replace the registration spine; it governs how the activated node routes identity, proof, AI agent, governance, asset-time, recovery, market, and clearing operations.

The controller may store a RouteTable having route_id, route_type, parent_node_id, child_node_id, policy_hash, authority_scope, endpoint_uri, access condition, audit pointer, failure mode, recovery route, and route_status. Route types may include identity_route, proof_route, AI_agent_route, governance_route, ATMS_route, mint_route, index route, market_route, data_room_route, recovery_route, and asset_time_route.

A domain-internal node map may record child nodes, service endpoints, branch nodes, terminal nodes, AI agents, market listings, proof sources, payment or clearing routes, index publishers, and standards certifiers under a single domain cluster or territory operator.

An AI agent route may be activated only when the agent node has an identity anchor, model or service descriptor, authority scope, data-use policy, safety policy, proof route, governance route, and remediation boundary. The controller may deny or limit the agent when the policy version is expired or the agent route conflicts with a market listing or privacy rule.

A governance route may process policy updates, standards updates, operator disputes, appeal events, voting records, revocation events, successor assignment, and public-interest overrides. Each governance event may produce a GovernanceReceipt and may modify only the scope authorized by the root record or PolicyContainer.

A recovery route may connect BEIFR2 remediation, domain recovery, operator replacement, route quarantine, proof reissuance, market delisting, and post-remediation FinalityMarker issuance. The recovery route supports bounded correction rather than system-wide invalidation.

An asset-time route may connect TimeCurrency, BEI Currency, BEIGDP, BEIIndex, resource reserves, domain reserves, patent reserves, and claim-to-SKU data-room outputs. The route allows time, behavior, domain, resource, and license records to be mapped into indices and asset packages under a standards profile.

A multi-route routing decision may be made by comparing node class, request type, access scope, proof status, policy version, route priority, route health, standards profile, and remediation state. The decision may return an allowed route, denied route, fallback route, manual review route, or BEIFR2 hold route.

The controller can be claimed as a dependent subsystem or as a continuation subject because it provides downstream orchestration after registration. In the present disclosure, it is described as implementation support for the active BEI Operating Node without diluting the core claim to registration-origin activation.

The technical advantage of the controller is that a domain becomes an operations fabric. It can route identity, proof, policy, AI, governance, settlement, recovery, asset-time, and data-room operations through verifiable route records instead of relying on disconnected dashboards or manual administration.

### Currency, Resource, and Index Routing Under the Same Root Record

A CurrencyRouteRecord may include route_id, root_record_id, unit_type, currency_class, jurisdiction, rail_type, settlement_policy, reserve_profile, exchange_profile, risk_profile, compliance_profile, proof_required, finality_rule, and remediation_rule.

Unit types may include BEI Currency, TimeCurrency, service unit, health unit, education unit, green unit, care unit, invention unit, voucher unit, reserve unit, index unit, wallet unit, internal accounting unit, and proof-only unit.

Fiat or external currencies may be referenced through settlement adapters and external rail records. A BEITLD root record may route to external rails without asserting that BEI units are legal tender or securities. Legal effect remains subject to external law and system rules.

A ResourceRouteRecord may include resource_id, resource_class, object type, physical or digital scope, authorized sensors or sources, proof requirement, time window, reserve policy, index policy, settlement route, and remediation boundary.

Resource classes may include domain resources, digital land, physical land, water, light, electricity, air, solar, medical service capacity, education capacity, retail terminal capacity, public-service capacity, data-room assets, patent resources, standards resources, and AI-agent service capacity.

For water, electricity, air, light, and solar resource nodes, the registry may bind a sensor, meter, device, institution, or public-service source to the root record. The proof chain may produce resource receipts and route them to green indices, reserve records, or public-service reports.

For TimeCurrency, the registry may require a time window, behavior category, proof source, subject-object relation, policy version, and replay-prevention state before a time-based unit is eligible for minting, indexing, or settlement.

For BEI Currency or BEI Unit outputs, the registry may require evidence quality, behavior class, reserve constraint, standards profile, risk score, and clearing route. The output may be utility, account, voucher, reserve, index, or regulated instrument depending on implementation.

For BEIGDP and BEIIndex outputs, the registry may aggregate only eligible receipts and route them according to privacy level, industry class, territory scope, confidence score, correction status, and standards profile.

The same root record can therefore connect all currencies and all resources by storing route pointers, not by promising universal monetary effect. The invention is the technical routing, proof, policy, and remediation structure that makes such conversion auditable and controllable.

### Examiner-Oriented Technical Contribution and Safety Framing

The core technical contribution is not the idea that domains are valuable. The contribution is a special-purpose registry machine that transforms a canonicalized BEI Time-Land-Resource registration intent into an active, proof-carrying, policy-governed BEI Operating Node through specific data structures, algorithms, proof artifacts, state transitions, and remediation boundaries.

The technical problem is that conventional registration, identity, payment, marketplace, and governance systems create disconnected records. They do not produce a single root record capable of operating as identity endpoint, policy endpoint, proof endpoint, clearing endpoint, market endpoint, index endpoint, governance endpoint, and remediation endpoint.

The technical solution is an ordered combination: canonical RIE, BEI Doorplate/BEDID binding, multidimensional NonDup gate, BEITLD root record, executable PolicyContainer, proof pipeline, FinalityMarker, ATMS and market activation, index routing, and BEIFR2 bounded remediation.

The system is not claimed merely as a method of organizing human activity. The system recites concrete computing operations: canonicalization, hashing, collision matrix lookup, pending lock creation, signed receipt generation, root record creation, policy injection, route activation, verifier reconstruction, dependency-graph computation, and finality marker issuance.

The system is not claimed merely as displaying information. The registry changes stored machine state by creating root records, node records, policy bindings, proof artifacts, route tables, lifecycle states, and remediation records that control subsequent machine access and clearing operations.

The system is not claimed merely as tokenization or blockchain usage. A blockchain, database, HSM, TEE, WordPress Multisite, cloud registry, smart contract, or ledger may be used as one implementation environment, but the inventive passage is the specific registration-origin transformation and proof-bound node activation.

The system is not claimed as an investment, currency guarantee, title-transfer system, or regulatory substitute. It may output technical records useful for clearing, index, data-room, valuation, licensing, or compliance analysis, subject to separate legal and commercial implementation.

For section 112 support, the disclosure includes representative schemas, algorithm steps, state machines, field names, reason codes, examples, node classes, adapters, interfaces, and safety boundaries. A person of ordinary skill can implement the system using conventional programming languages, databases, cryptographic libraries, API gateways, identity systems, and registry infrastructure.

For section 102 support, the ordered combination is materially different from a conventional registrar, DID registry, ENS system, payment rail, marketplace, franchise database, or workflow engine because none produces the disclosed active BEI Operating Node with the specified proof, policy, clearing, index, and remediation structure from a registration intent.

For section 103 support, even if individual components existed separately, the present registration-origin combination changes the output and operating state of the registry. The motivation is not merely to combine familiar tools, but to solve the technical gap of producing an auditable, clearable, searchable, licensable, remediable, and governance-aware operating node at the moment of registration.

### Preservation of Original Theme and Continuation Strategy

This disclosed supplement preserves all prior disclosed subject matter and does not intentionally remove any useful definition, field, state, proof artifact, example, drawing mapping, or claim-support statement. The purpose is to strengthen and extend written-description support while keeping the same focused registration spine.

The present file should be treated as the strengthened main BEITLD registration specification, not as a new theme. The theme remains registrar-like registration from beginning to end, but the machine result is a BEI Time-Land-Resource Operating Node rather than a conventional domain record.

Continuation and continuation-in-part filings may later focus on specialized subsystems, including Sovereign Domain Operations Controller, provisioning plugin, IdentityOS, RoutingOS, MintOS, BEI Logic software chip, BEIFR2 recovery controller, ATMS clearing kernel, and sector-specific IndustryPacks.

A dependent or continuation claim may recite the external infrastructure adapter for company formation, registered agent, corporate status, domain registration, industry operator, and regional operator records. Another dependent or continuation claim may recite the Sovereign Domain Operations Controller and its multi-route table.

The strongest independent claim should remain focused on the special-purpose registry machine. It should not be overloaded with every sector, every currency, or every resource. Those details provide support, examples, dependent claims, continuation claims, and licensing fields.

The specification may support 999 needs, 365 industries, all currencies, and all resources by using registry matrices and route records. This approach provides breadth without losing definiteness because each field is mapped to schema elements and execution routes.

The asset-package value is enhanced by keeping the main patent readable to an examiner while using appendices, data-room schedules, product packages, claim-to-SKU maps, and industry matrices to show commercial scope and licensing paths.

If a prosecution response later becomes necessary, the applicant may rely on this specification to argue that the claim is directed to a concrete improvement in registry computing: the transformation of a registration intent into an active, proof-carrying, policy-governed, remediable operating node.

If a data-room reviewer evaluates the application, the reviewer can follow a single path: ADS technical family, registration spine, data object schemas, claim support index, node classes, IndustryPack matrix, product implementation path, territory operator rules, currency and resource routing, and asset-package outputs.

The invention should therefore be understood as a coherent BEITLD registration operating system. It is wider and more valuable than a single domain name, but it remains specific because every expansion is routed through root record, PolicyContainer, proof chain, FinalityMarker, and BEIFR2 boundary.

Representative Sector Examples with Machine Inputs and Outputs

Example A, personal identity doorplate: input fields include applicant identity, requested doorplate, contact proof, signature set, time window, and identity policy. The output is a BEDID, DoorplateBindingRecord, root record, identity endpoint, proof route, and privacy-controlled lookup route.

Example B, family time bank: input fields include family operator, family members, care categories, authorized proof sources, time window, privacy rules, and TimeCurrency route. The output is a family node, care receipt route, family reserve record, and remediation boundary for erroneous care claims.

Example C, merchant retail node: input fields include merchant BEDID, store slug, root domain, product SKU, payment route, tax or compliance adapter, and parent franchise if any. The output is a retail node, store endpoint, ATMS route, customer receipt route, and market listing eligibility.

Example D, franchise territory node: input fields include franchisor BEDID, franchisee BEDID, territory scope, industry field, service classes, royalty formula, quality rules, and operator term. The output is a franchise root record, child node permission, royalty basis, governance rule, and BEIFR2 boundary.

Example E, city public-service node: input fields include city or agency credential, service class, public-interest profile, emergency priority, privacy rule, and standards profile. The output is a city node, public-service endpoint, audit route, reporting index, and public-service remediation rule.

Example F, medical provider node: input fields include provider credential, medical service class, patient privacy rule, evidence source, insurance or grant route, and health standards profile. The output is a medical node, health receipt route, scope-token access rule, and health-index route.

Example G, education credential node: input fields include institution credential, course identifier, instructor identity, student privacy rule, credential schema, and policy version. The output is an education node, learning receipt, skill-index route, and credential verification endpoint.

Example H, green resource node: input fields include resource source, sensor or institution proof, water/air/electricity/solar class, time window, quality score, and green standards profile. The output is a resource node, green receipt, reserve update, and environmental index route.

Example I, AI agent node: input fields include model identifier, operator BEDID, service scope, data policy, safety rule, audit endpoint, and remediation rule. The output is an AI-agent route with authority limitation, proof trace, governance route, and recovery route.

Example J, invention and patent-wall node: input fields include inventor identity, filing receipt, claim-family pointer, technical module, product SKU, licensing field, and standards tag. The output is a patent-wall node, claim-to-SKU map, data-room record, and licensing route.

Example K, exchange listing node: input fields include asset node, proof artifact set, FinalityMarker, reserve profile, market policy, disclosure rule, and remediation boundary. The output is a market listing, listing status, data-room pointer, clearing route, and delisting rule.

Example L, cross-border operator node: input fields include regional operator credential, local formation record, registered agent or representative record, local domain record, external registry link, and cross-border policy. The output is a limited regional operator node with local adapter and BEITLD root proof.

Example M, terminal and IoT node: input fields include device identifier, owner BEDID, device key, terminal class, proof source, offline cache rule, and synchronization policy. The output is a terminal node, signed endpoint, device receipt route, and retry or quarantine rule.

Example N, data-room asset node: input fields include domain asset pointer, patent family pointer, product SKU, proof artifacts, license field, valuation scenario tag, and disclosure scope. The output is a data-room node with claim chart, evidence link, and access-controlled proof package.

Example O, remediation event: input fields include dispute trigger, affected artifact, complainant identity, prior FinalityMarker, dependency graph, authority threshold, and proposed correction. The output is a BEIFR2 RemediationRecord, affected_node_set, unaffected_node_set_hash, correction receipt, and post-remediation FinalityMarker.

Each representative example uses the same technical spine. The category changes, but the machine flow does not: intake, canonicalization, identity binding, multidimensional conflict check, policy injection, proof artifact generation, route activation, finality marking, and bounded remediation.

### Final Preservation Statement

The disclosure above preserves the disclosed registration-origin invention while adding ADS coordination, family matrix support, NeedPack and IndustryPack implementation support, all-currency and all-resource routing, product and provisioning examples, founder-domain continuity, territory operator assignment, Sovereign Domain Operations Controller support, and examiner-oriented technical contribution statements.

The strongest reading remains: the invention protects the necessary technical passage by which a BEI Time-Land-Resource registration request enters the BEI behavioral-economic identity system and becomes an active, proof-carrying, policy-governed, clearable, indexable, licensable, and remediable operating node.

This final preservation statement is intended to prevent dilution of the theme. All added examples are subordinate to the registration spine and should be interpreted as implementation support, dependent claim support, continuation support, licensing fields, and asset-package support for the same BEITLD sovereign registration operating system.

### Additional Registry Implementation Safeguards

In one implementation, the registry maintains a separate audit copy of each canonical registration intent digest, root record hash, PolicyContainer hash, proof-root hash, and FinalityMarker hash. The audit copy may be stored in an append-only log, a ledger commitment, a secure database table, or a data-room evidence package so that a verifier can compare the active node state with the original activation evidence.

In another implementation, the registry assigns a standards_profile_id to each node at activation and prevents downstream minting, clearing, index publication, market listing, or operator reassignment unless the standards profile remains current or an approved migration receipt has been issued.

In another implementation, an operator cannot expand from a territory node into a franchise node, retail node, market node, or public-service node without a separate scope expansion event. The scope expansion event is processed as a new registration intent linked to the parent_node and is subject to the same multidimensional NonDup controller.

In another implementation, all child nodes inherit only those route permissions expressly marked as inheritable in the parent PolicyContainer. Non-inheritable permissions require a new proof artifact and a new FinalityMarker before they can be used by a child node.

In another implementation, renewal of a BEITLD root record is not treated merely as payment. Renewal may re-check operator identity, policy version, standards profile, unresolved disputes, expired proof artifacts, and open remediation holds before the lifecycle state remains active.

In another implementation, transfer of a node is treated as a controlled state transition. The transfer record may include transferor BEDID, transferee BEDID, scope restrictions, unpaid royalty status, pending remediation status, data-room notice, and post-transfer FinalityMarker.

In another implementation, suspension may preserve the root record and proof chain while disabling selected routes. For example, a node may be suspended from market listing but remain visible for resolver lookup, audit, public-service continuity, or BEIFR2 remediation.

In another implementation, deletion or archival does not erase the proof chain. The system may mark the node as archived, preserve audit pointers, prevent new route activations, and retain remediation information for a policy-defined retention period.

In another implementation, the registry publishes a machine-readable implementation profile showing which optional modules are enabled, including BEIDNS resolution, ATMS clearing, BEIMINT conversion, BEIFR2 remediation, BIRSTDSEC certification, data-room output, and Sovereign Domain Operations Controller routing.

In another implementation, a registry operator may expose testing endpoints or sandbox endpoints. Sandbox outputs may be marked non-final and may not activate market listing, clearing, or index routes until a production FinalityMarker is issued.

In another implementation, the registry may provide an examiner or auditor reconstruction package containing sample RIE, canonical intent digest, NonDup reason code table, root record, PolicyContainer, proof artifacts, FinalityMarker, BEIFR2 dependency graph, and route table. This package can be used to demonstrate the technical nature of the claimed machine process.

In another implementation, a claim-to-SKU record can show how each claim element maps to a commercial or public-service module. The record may include claim identifier, data object, API endpoint, node class, product SKU, domain asset pointer, patent-family pointer, standards profile, and license field.

### Final Registrar-Function Mapping, Child-Node Enablement, and Asset-Package Support

For claim-support clarity, the disclosed registry interface may expose user-facing functions that correspond to registrar-grade functions while preserving a different technical back-end. The technical back-end records the input envelope, NonDup collision matrix, policy version, proof artifacts, FinalityMarker, route pointers, and remediation boundary for each material action.

A domain-search function may receive a string, time-land-resource coordinate, industry field, need class, operator class, or parent namespace. The output may be a structured availability report comprising availability_state, reason_code, conflicting_record_hash, pending_lock_identifier, policy_route, required_RFP_flag, candidate_node_class, and permitted_child_classes.

A registration function may produce a BEITLD root record instead of a passive registry row. The root record binds a BEI Doorplate or BEDID to a Time-Land-Resource scope and carries route pointers to signed endpoints, proof artifacts, ATMS synchronization, market listing eligibility, index routing, governance status, and BEIFR2 remediation controls.

A DNS-management or resolver function may be implemented as signed endpoint management and resolution-as-evidence. The node owner or operator may update endpoint records only when the PolicyContainer authorizes the update and when the resulting endpoint manifest is bound to a new Resolution Receipt or equivalent proof artifact.

A renewal function may verify that the registrant identity, PolicyContainer version, standards profile, ATMS fee or settlement reference, NonDup status, and remediation state remain valid. The renewal record preserves the root_record_id and updates the lifecycle log without destroying prior proof artifacts.

A transfer function may change operator BEDID, authorized role, or control key while preserving historical receipts. The transfer may require transferor authorization, transferee acceptance, policy approval, pending-remediation check, ATMS settlement clearance, and issuance of a transfer FinalityMarker.

An owner-lookup function may be implemented as privacy-filtered public disclosure plus scope-token disclosure. Public users may receive node existence, lifecycle state, and hash commitments, while authorized users may receive additional BEDID, operator, franchise, medical, financial, or data-room fields according to policy rules.

A bundled package function may be implemented by selecting a node class and PolicyContainer bundle. For example, a medical bundle may activate medical privacy filters and health standards; a financial bundle may activate ATMS routes and stricter nonce checks; a retail bundle may activate terminal endpoints and market eligibility; a public-service bundle may activate emergency access and public-interest governance rules.

A marketplace or appraisal function may be implemented by publishing a DataRoomRecord, BEIMarket listing, BEIIndex route, BEIGDP record, DomainYLD record, or license-field package. The system generates evidence records and route pointers but does not guarantee a market price, legal title, investment return, or regulatory approval.

The child-node spawning mechanism supports large-scale personalization. A parent BEITLD namespace or parent BEI Operating Node may spawn a bounded tree of child nodes for household, territory, franchise, chain, retail, medical, education, IoT, government, AI-agent, public-service, market, or data-room usage. Each child node carries its own proof chain, policy inheritance digest, NonDup receipt, and remediation boundary.

In one implementation, thousands of BEI Time-Land-Resource registry classes may be presented to registrants through a familiar selection interface. The fact that a user selects a class or package does not change the technical operation: the registry still performs canonicalization, NonDup review, root-record creation, PolicyContainer injection, proof-chain generation, FinalityMarker issuance, and bounded-remediation setup.

For asset-package diligence, the system may generate a ClaimToSkuRecord comprising claim_element_id, technical_module_id, root_record_pointer, proof_artifact_pointer, licensing_field, sector_tag, operator_scope, royalty_basis_field, risk_disclosure_pointer, and audit_anchor. This record maps technical claims to deployable modules without turning the patent claim into a financial promise.

For continuation support, the same registration spine can be narrowed or specialized into separate applications directed to NonDup controller architecture, FinalityMarker data object, BEIFR2 bounded remediation, child-node spawning, ATMS deterministic clearing, BEIRFP operator assignment, IndustryPack deployment, NeedPack routing, and Sovereign Domain Operations Controller embodiments.

The formal filing should maintain the core claim chain and use the broader portfolio materials as support rather than as a substitute for claim clarity. The strongest claim posture is to protect the specific machine transformation and then use related applications, data-room schedules, product packages, and continuation filings to cover particular sectors and commercial deployments.

The ultimate technical output is a BEI Time-Land-Resource Operating Node that can be searched, registered, renewed, transferred, resolved, disclosed, listed, cleared, governed, audited, and remediated through machine-readable records. This is the focused invention, and all examples should be read as implementations of that registration-origin machine pathway.

What is claimed is:

1. A computer-implemented Behavioral Economic Identity (BEI) Time-Land-Resource Domain registration operating system operating as a special-purpose registry machine configured to transform a registration intent into an active, proof-carrying, policy-governed BEI Operating Node, the system comprising: one or more processors; and a memory storing instructions that, when executed by the one or more processors, cause the system to: receive a BEI registration intent envelope comprising an applicant identity cryptographic reference, a requested Time-Land-Resource Domain scope, a requested node class, an evidence digest, a policy-template reference, a time reference, and a signature set; canonicalize the requested Time-Land-Resource Domain scope to generate an intent digest and a nonduplication scope key; generate or bind a BEI Doorplate or BEDID for the applicant; execute a multi-dimensional NonDup/NonConflict/NonOverlap controller against existing and pending records to evaluate at least label duplication, identity collision, time-scope conflict, land or resource overlap, territory overlap, franchise overlap, retail-node conflict, market-listing duplication, and policy collision; responsive to an allowed result, create a BEITLD root record binding the BEI Doorplate or BEDID to the requested Time-Land-Resource Domain scope; inject an executable PolicyContainer into or in association with the BEITLD root record; activate a BEI Operating Node corresponding to the requested node class; generate proof artifacts comprising at least a Resolution Receipt, a NonDuplicationReceipt, an authorization or clearing receipt, and a FinalityMarker; and generate the FinalityMarker as a data object comprising a root_record_id field referencing the BEITLD root record, a node_state field, a proof_root_hash field comprising a Merkle root of cryptographic hashes of each proof artifact in the proof artifact pipeline, an audit_anchor field comprising a trusted-time-authority signature over the proof_root_hash, an ATMS pointer field, a BEIMarket pointer field, a BEIGDP or BEIIndex pointer field, and a BEIFR2 boundary field specifying a bounded remediation scope.

2. The system of claim 1, wherein the requested node class is selected from a BEI base node, territory node, RFP operator node, franchise node, chain node, retail node, market node, medical node, ATMS node, index node, governance node, resolver node, data-room node, or sector node.

3. The system of claim 1, wherein the BEI registration intent envelope is generated from a BEIRFP proposal intake portal that converts a global, regional, industry, system, store, franchise, standards, market, or governance proposal into the BEI registration intent envelope after applicant selection.

4. The system of claim 1, wherein the NonDup/NonConflict/NonOverlap controller generates a machine-readable reason code selected from label reserved, label duplicate, identity collision, time-window overlap, land-scope overlap, resource-scope conflict, territory conflict, franchise overlap, retail-node conflict, market-listing duplicate, policy collision, replay, pending lock, scope-token expiration, standards-profile failure, or BEIFR2 remediation hold.

5. The system of claim 1, wherein the BEITLD root record comprises a root record identifier, canonical label hash, BEDID, node class bitmask, time scope, land scope, resource scope, territory scope, industry scope, parent root identifier, policy container identifier, signed endpoint set, proof root, ATMS route identifier, FinalityMarker identifier, lifecycle state, and creation timestamp.

6. The system of claim 1, wherein the executable PolicyContainer defines registration eligibility, identity requirements, evidence requirements, field-level disclosure rules, territory rules, franchise rules, chain expansion rules, retail permissions, market listing constraints, ATMS settlement parameters, standards compliance profile, governance rights, revocation rules, and BEIFR2 remediation boundaries.

7. The system of claim 1, wherein activation of the BEI Operating Node comprises transitioning through lifecycle states selected from reserved, queued, nondup checked, policy bound, root record created, endpoint provisioned, proof generated, initialized, active, delegated, market listed, suspended, frozen, remediated, transferred, archived, or retired, and wherein each state transition is recorded in an append-only state-transition log.

8. The system of claim 1, wherein the Resolution Receipt includes a result set or denial indication, a reason code, a policy hash, a policy version, a scope-token digest, a revocation reference, a rollback reference, a time-to-live value, an audit anchor, and a signature chain, and wherein the Resolution Receipt is structured to enable verifier reconstruction of a registration decision from the intent digest and policy version.

9. The system of claim 1, wherein the ATMS pointer field references a deterministic clearing kernel configured to resolve a namespace address into a hierarchical account graph, compute a canonical transaction hash, execute a nonce anti-replay gate, apply a settlement matrix, and return a verifier-reconstructable proof set.

10. The system of claim 1, wherein the BEI Operating Node is classified as a franchise, chain, retail, or market node and the PolicyContainer defines a corresponding operator scope, franchise scope, chain scope, retail scope, market scope, royalty basis, ATMS route, data-room route, and remediation boundary.

11. The system of claim 1, wherein BEIFR2 bounded remediation generates a remediation record comprising a pre-remediation snapshot hash, affected root records, trigger vector, policy authorization, impact-set digest, post-remediation state hash, and receipt signature, wherein remediation is limited to affected nodes determined from a dependency graph, and wherein a BEIFR2 state machine enforces at least one quantitative bound selected from maximum rollback depth, maximum value-at-risk, maximum node count, dependency depth, or multi-party authorization threshold for material remediation actions.

12. A computer-implemented method comprising: receiving a BEI Time-Land-Resource Domain registration request; canonicalizing a requested label and requested time-land-resource scope; generating an intent digest and nonduplication scope key; selecting or generating a BEI Doorplate or BEDID; checking the request for non-duplication, non-conflict, and non-overlap against registry records and pending locks using a multi-dimensional NonDup/NonConflict/NonOverlap controller; creating, when allowed, a BEITLD root record; binding the root record to an executable PolicyContainer; provisioning one or more signed endpoint records; activating a BEI Operating Node; generating proof artifacts comprising a Resolution Receipt, NonDuplicationReceipt, FinalityMarker, and audit anchor; and generating, upon activation of the BEI Operating Node, a FinalityMarker data object comprising activation pointers to at least one of an ATMS route, BEIMarket route, BEIIndex route, BEIGDP route, governance route, or BEIFR2 remediation route.

13. The method of claim 12, further comprising performing a pre-registration BEIDNS resolution-as-evidence lookup that returns an allowed Resolution Receipt or a denial receipt before converting the lookup into the BEI Time-Land-Resource Domain registration request.

14. The method of claim 12, further comprising receiving a selected RFP applicant record and generating an operator root record, scope token, authority marker, and RFP-to-BEITLD registration intent envelope.

15. The method of claim 12, wherein spawning child nodes comprises generating personalized second-level domain nodes or subdomain nodes under a selected BEITLD parent namespace, BEI Time-Land-Resource registry class, or parent BEI Operating Node, each child node inheriting at least one parent PolicyContainer rule, governance boundary, standards profile, or BEIFR2 remediation boundary and independently passing the multidimensional NonDup/NonConflict/NonOverlap controller before activation.

16. The method of claim 12, further comprising binding a BIRSTDSEC standards profile to the PolicyContainer, wherein the standards profile defines field schemas, algorithm identifiers, signature requirements, audit retention, privacy filtering, reason-code taxonomy, dispute routing, and remediation boundaries.

17. The method of claim 12, further comprising receiving a trusted execution input comprising a TimeChip, signed asset-state record, HSM attestation, TEE attestation, secure-element attestation, or BEIChip output before final node activation.

18. The method of claim 12, further comprising routing a service event, product event, medical-health event, care event, franchise event, retail event, public-service event, licensing event, or asset-package event through a BEI-TOT or BEI-SOS fission layer after activation of the BEI Operating Node.

19. The method of claim 12, further comprising publishing a data-room record that maps the BEI Operating Node to a root record, policy version, proof artifact set, domain asset pointer, patent-family pointer, market listing identifier, license field, royalty basis, audit anchor, and remediation status.

20. A non-transitory computer-readable medium storing instructions that, when executed by one or more processors, cause the one or more processors to perform operations comprising: receiving and canonicalizing a BEI Time-Land-Resource Domain registration intent envelope; generating or binding a BEI Doorplate or BEDID; executing multidimensional NonDup/NonConflict/NonOverlap checks; creating a BEITLD root record; injecting an executable PolicyContainer; activating a BEI Operating Node; generating proof artifacts including at least a Resolution Receipt, NonDuplicationReceipt, authorization or clearing receipt, FinalityMarker, and rollback proof, exposing endpoints for value-state search, ATMS synchronization, RFP or operator binding, territory/franchise/chain/retail/market classification, index routing, governance transition, standards binding, and BEIFR2 bounded remediation; and recording receipt-bound state transitions for verifier reconstruction.
